(19) United States
(12) Patent Application Publication
(10) Pub. No.: US 2026/0119855 A1
(43) Pub. Date: Apr. 30, 2026

(54) PROCEDURAL MULTI-STAGE VECTOR QUANTIZATION FOR LOW PRECISION INTEGER NEURAL NETWORK WEIGHTS

(71) Applicant: QUALCOMM Incorporated, San Diego, CA (US)

(72) Inventors: Amir Said, San Diego, CA (US); Hoang Cong Minh Le, Santee, CA (US); Farzad Farhadzadeh, San Diego, CA (US)

(21) Appl. No.: 18/931,527

(22) Filed: Oct. 30, 2024

(51) Int. Cl. G06N 3/0495

(52) U.S. Cl. CPC G06N 3/0495

(57) ABSTRACT

An example computing device may include memory and one or more processors. The one or more processors are configured to determine a Cartesian grid in a space. The Cartesian grid may correspond to a precision of an arithmetic processing unit. The one or more processors are configured to, for each of a plurality of neural network weights, determine a respective vector in the space, such that each respective vector belongs to a corresponding predefined vector on the Cartesian grid and represents a respective compressed neural network weight of a plurality of compressed neural network weights. The one or more processors are configured to execute, based on the plurality of compressed network weights, a neural network. The one or more processors are configured to generate, based on executing the neural network, an output.

### TECHNICAL FIELD

This disclosure relates to vector quantization for neural network weights.

### BACKGROUND

Neural networks have been shown to be effective solutions in a wide range of applications. A neural network may include three types of layers of nodes, namely an input layer, one or more hidden layers, and an output layer. The input layer may receive inputs, such as values from which the neural network as a whole generates an output. The output of each node of the input layer may be provided to each node of a first layer of hidden layers. Each input from the input layer may be multiplied by a weight (e.g., a neural network weight) and then summed at each node of hidden layers. Such weights are determined or adjusted during training of neural network to establish a relationship between the input data and output data. Output of each node of the first hidden layer are provided to each node of a next hidden layer, and so on, when there are more than one hidden layer. The output layer may be provided with the output of each node of the last hidden layer. The output layer may include a transfer function and may output an inference, prediction, classification, etc. which is based on the input data and the neural network weights. The neural network weights are commonly computed as floating-point values.

### SUMMARY

In general, this disclosure describes techniques for vector quantization for neural network weights. Neural-based coding techniques are commonly designed and tested using high-precision floating-point mathematics. However, as neural network-based media compression techniques move into practical implementation and deployment, neural network weights and activation functions may be quantized and represented with low-precision integers, rather than high-precision floating-point numbers, in order to improve speed and power consumption.

This disclosure addresses problems of that occur when attempting to reduce the stored and utilized neural network weights to integer representations in order to save processing power and/or memory. The use of scalar quantization (SQ) or standard vector quantization (VQ) together with or without entropy coding do not result in compressed neural network weights that may be effectively used in a neural network that may require fast, parallelized decompression, and quantization outputs that match low-precision arithmetic units (e.g., 4-bit-only multipliers for neural network weights).

This disclosure describes techniques for data compression that utilize a modified VQ definition. The techniques of this disclosure may use a Cartesian grid constrained vector quantization (CGC-VQ) which may be useful for the compression of neural network weights for neural networks that require fast, parallelized decompression and output compatible with low-precision arithmetic units. While primarily described herein with respect to neural network weight compression, the techniques of this disclosure may be used for data compression generally.

In one example, a device includes: one or more memories for storing parameters of a neural network; and one or more processors configured to: determine a Cartesian grid in a space, wherein the Cartesian grid corresponds to a precision of an arithmetic processing unit; determine, for each of a plurality of neural network weights, a respective vector in the space, such that each respective vector belongs to a corresponding predefined vector on the Cartesian grid and represents a respective compressed neural network weight of a plurality of compressed neural network weights; execute, based on the plurality of compressed network weights, the neural network; and generate, based on executing the neural network, an output.

In another example, a method includes determining a Cartesian grid in a space, wherein the Cartesian grid corresponds to a precision of an arithmetic processing unit; determining, for each of a plurality of neural network weights, a respective vector in the space, such that each respective vector belongs to a corresponding predefined vector on the Cartesian grid and represents a respective compressed neural network weight of a plurality of compressed neural network weights; executing, based on the plurality of compressed network weights, the neural network; and generating, based on executing the neural network, an output.

In another example, non-transitory computer-readable storage media is encoded with instructions that when executed by one or more processors, cause the one or more processors to: determine a Cartesian grid in a space, wherein the Cartesian grid corresponds to a precision of an arithmetic processing unit; determine, for each of a plurality of neural network weights, a respective vector in the space, such that each respective vector belongs to a corresponding predefined vector on the Cartesian grid and represents a respective compressed neural network weight of a plurality of compressed neural network weights; execute, based on the plurality of compressed network weights, the neural network; and generate, based on executing the neural network, an output.

In another example, a device includes means for determining a Cartesian grid in a space, wherein the Cartesian grid corresponds to a precision of an arithmetic processing unit; means for determining, for each of a plurality of neural network weights, a respective vector in the space, such that each respective vector belongs to a corresponding predefined vector on the Cartesian grid and represents a respective compressed neural network weight of a plurality of compressed neural network weights; means for executing, based on the plurality of compressed network weights, the neural network; and means for generating, based on executing the neural network, an output.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example media encoding and decoding system that may perform the techniques of this disclosure.

FIG. 2 is a block diagram illustrating an example computing device that may perform techniques of this disclosure.

FIG. 3 is a conceptual diagram illustrating example reproduction values and quantizer assignment regions for uniform scalar quantization with M=3, non-uniform scalar quantization with M=3, and vector quantization in a two-dimensional space with N=6.

FIG. 4A is a block diagram illustrating an example of entropy coding parallelization using multiple independent bitstreams and a header with decoder entry points.

FIG. 4B is a block diagram illustrating an example of vector quantization with a constant bitrate, allowing random access to compressed data, and scalable decoder parallelization after compression.

FIG. 5 is a block diagram illustrating an example of multi-stage residual vector quantization for codebook memory reduction.

FIG. 6 is a conceptual diagram illustrating an example mapping from integer matrix element to NN weights normalized to an interval of [−1,1].

FIG. 7A is a graphical diagram illustrating an example of two-dimensional CGC-VQ problem with code vector candidates and vectors from a training set.

FIG. 7B is a graphical diagram illustrating an example graph for p-median problem formulation.

FIG. 8 is a block diagram illustrating an example system for implementing procedural multi-stage CGC-VQ, with exponential reduction of codebook memory requirements according to one or more aspects of this disclosure.

FIG. 9 is a graphical diagram illustrating an example of separable non-uniform quantization to generate training sets, enabling average probabilities and expected distortions to be pre-computed from probability distribution models.

FIG. 10 is a block diagram illustrating an example system for implementing procedural multi-stage CGC-VQ, with exponential reduction of codebook memory requirements according to one or more aspects of this disclosure.

FIG. 11 is a graphical diagram illustrating example of how the symmetry in the probability distribution is exploited within the procedural for two-dimensional CGC-VQ stages, with the index of the vector's region being coded in a first stage, followed by the index of the vector within the region in a second stage.

FIG. 12 is a conceptual diagram illustrating single stage and two stage two-dimensional CGC-VQ optimized for squared-error distortion.

FIG. 13 is a conceptual diagram illustrating single stage and two stage two-dimensional CGC-VQ with the data of FIG. 12, but optimized using the L₄ distortion measure.

FIG. 14 is a conceptual diagram illustrating single stage and two stage for two-dimensional CGC-VQ with different distortion measures.

FIG. 15 is a graphical diagram illustrating a comparison of two-dimensional VQ performance with scalar quantization using 4 bits/weight as reference, and between single stage (asymmetric) and two stages (symmetric).

FIG. 16 is a flow diagram illustrating example vector quantization techniques according to one or more aspects of this disclosure.

### DETAILED DESCRIPTION

This disclosure describes techniques for data compression. Such data compression techniques may be referred to herein as Cartesian grid constrained vector quantization (CGC-VQ) techniques. CGC-VQ techniques may be useful when attempting to use data compression in fast and highly parallelized computation environments. For example, CGC-VQ techniques may be useful for neural network weight compression, where computations may be made quickly and in a highly parallelized manner. CGC-VQ techniques may provide a solution to a compression issue with neural network weights that may not be solved by traditional techniques as described throughout this disclosure.

Neural networks have been shown to be effective solutions in a wide range of applications, but deployment of neural networks is limited by computational complexity and power demands. One way to reduce power consumption of a neural network is to use neural network weights of relatively low precision integers, e.g., 4 or 8 bits per weight. Arithmetic operations on relatively low precision integers are less power intensive than arithmetic operations on higher precision values including more bits per weight. As such, in some examples, implementation may be practically constrained to operate within a particular precision (e.g., 4 or 8 bits per weight) of an arithmetic processing unit.

Efficiency can be further improved by compressing neural network weight values, since such compression reduces the power needed for copying neural network weight data. However, compressing neural network weight values may require compression techniques capable of supporting the relatively high throughput of parallel neural network computations and may only be achieved through the use of very fast and highly parallelized compression.

Because neural network weights are much less compressible than, for example, video data, it is relatively difficult to design lossless entropy coding techniques that can be effectively parallelized and be sufficiently fast to operate with compressed neural network weights. This difficulty may arise because such techniques may require asynchronous execution, and may not be matched to commonly available and efficient single-instruction-multiple-data/-thread (SIMD/SIMT) architectures and accelerators.

Under such conditions, VQ may become a more efficient option for neural network weight compression, because VQ can provide constant bitrates, enable more parallelization through random access to compressed data, and is a relatively good fit to SIMD/SIMT and multi-core architectures. While VQ has been previously studied, the problem presented by compressing neural network weights is different than previous problems for which VQ has been used because vector elements must maintain the integer precision used for arithmetic operations, and well-known techniques for VQ optimization may not be successfully employed. Similarly, previously used multi-stage VQ techniques for complexity reduction would need to be modified in order to preserve neural network weight lattices.

This disclosure describes optimization and coding techniques designed specifically for a new type of vector quantization, which may be referred to herein as Cartesian grid constrained vector quantization (CGC-VQ). This disclosure describes algorithms for finding an optimal or preferred set of code vectors (CGC-VQ codebook) and a low-complexity multi-stage implementation designed to satisfy integer weight outputs using procedural stages. The disclosed system has very low complexity because stages can be implemented with low-memory table look-up, binary XOR, and/or “shuffle” (permutation) operations, that can be parallelized simultaneously on multiple cores and SIMD/SIMT accelerators.

Experimental results with actual neural network weight data demonstrate the effectiveness of the disclosed design and show that the proposed multi-stage implementation greatly reduces complexity with little VQ performance degradation.

Research on applying neural network to mainstream and new applications is ongoing, showing that neural network can provide significant performance improvement via deep-learning techniques. Sec, e.g., Siwei Ma, Xinfeng Zhang, Chuanmin Jia, Zhenghui Zhao, Shiqi Wang, and Shanshe Wang, “Image and video compression with neural networks: a review,” IEEE Trans. Circuits Syst. Video Technol. 30 (6), pp. 1683-1698 June 2020; Kaoru Ota, Minh Son Dao, Vasileios Mezaris, and Francesco De Natale. “Deep learning for mobile multimedia: a survey,” ACM Transactions on Multimedia Computing, Communications, and Applications, vol. 13 (3), pp. 1-22, 2017; and Khizar Hayat, “Multimedia super-resolution via deep learning: a survey,” Digital Signal Processing, vol. 81, pp. 198-217, 2018. However, for demanding applications like video compression and processing, large language models, etc., those solutions cannot be practically deployed (e.g., on a mobile device) if the complexity and power demands are not significantly reduced.

To address the complexity issue, new specialized hardware, frequently called “neural accelerators,” is being introduced. Neural accelerators attempt to exploit the fact that neural networks can be efficiently parallelized. Information on neural accelerators may be found in Anthony Cabrera, Seth Hitefield, Jungwon Kim, Seyong Lee, Narasinga Rao Miniskar, and Jeffrey S. Vetter, “Toward performance portable programming for heterogeneous systems on a chip: a case study with Qualcomm Snapdragon SoC,” 2021 IEEE High Performance Extreme Computing Conference, pp. 1-7, 2021; Norman P. Jouppi, Cliff Young, Nishant Patil, and David Patterson, “A domain-specific architecture for deep neural networks,” Communications of the ACM, vol. 61 (9), pp. 50-59, 2018; and Haitong Li, Mudit Bhargava, Paul N. Whatmough, and H S. Philip Wong, “On-chip memory technology design space explorations for mobile deep neural network accelerators,” In Proc. 56th ACM Annual Design Automation Conf., pp. 1-6. 2019.

Nevertheless, careful optimization and the quantification of neural network weights to run on neural accelerators is still desirable. See, e.g., Hoang Le, Liang Zhang, Amir Said, Guillaume Sautiere, Yang Yang, Pranav Shrestha, Fei Yin, Reza Pourreza, and Auke Wiggers, “Mobilecodec: neural inter-frame video compression on mobile devices,” In Proc. 13th ACM Multimedia Systems Conf., pp. 324-330, 2022; and T. Liang, J. Glossner, L. Wang, S. Shi, and X. Zhang, “Pruning and quantization for deep neural network acceleration: a survey,” Neurocomputing, vol. 461, pp. 370-403, October 2021.

During neural network optimization, power consumption can be reduced by lowering the number of neural network layers and operations. However, such lowering of the number of neural network layers and operations, can quickly result in severe performance degradation. An alternative design, which may significantly reduce power consumption while maintaining performance, is to use neural network weights with low precision integers in specialized accelerators. See, e.g., Benoit Jacob, Skirmantas Kligys, Bo Chen, Menglong Zhu, Matthew Tang, Andrew Howard, Hartwig Adam, and Dmitry Kalenichenko, “Quantization and training of neural networks for efficient integer-arithmetic-only inference,” In Proc. IEEE Conf. on Computer Vision and Pattern Recognition, pp. 2704-2713. 2018; M. Nagel, M. van Baalen, T. Blankevoort, and M. Welling, “Data-free quantization through weight equalization and bias correction,” in Proc. IEEE/CVF Int. Conf. Computer Vision, Oct. 2019; and M. Nagel, M. Fournarakis, R. A. Amjad, Y. Bondarenko, M. van Baalen, and T. Blankevoort, “A white paper on neural network quantization,” arXiv: 2106.08295v1, June 2021. The use of neural network weights with low precision integers may greatly reduce the power needed per operation and the amount of weight data that must be moved, which is also important because a significant portion of power consumption may be due to data movement within a system on a chip (SoC). Low precision floating-point formats may also be used, but are less efficient.

Neural network weight compression is now discussed. In neural network accelerators, the power needed per neural network weight operation is fixed by the hardware implementing integer operations, but the power for data movement can be further lowered by compressing the neural network weights.

Neural network weight compression can be classified as a lossy type of data compression because the neural network weights are first computed during neural network training using high-precision floating-point values and gradients, and there is performance loss when those neural network weights are converted to integer values.

An example use of a neural network which may use such neural network weights is in media coders (e.g., image and/or video). While the techniques of this disclosure are not limited to neural network weight compression for media coders, or even to neural network weight compression itself, an example of a media coder is set forth below. The use of the techniques of this disclosure may improve the ability to effectively implement a neural network media coder on a mobile device.

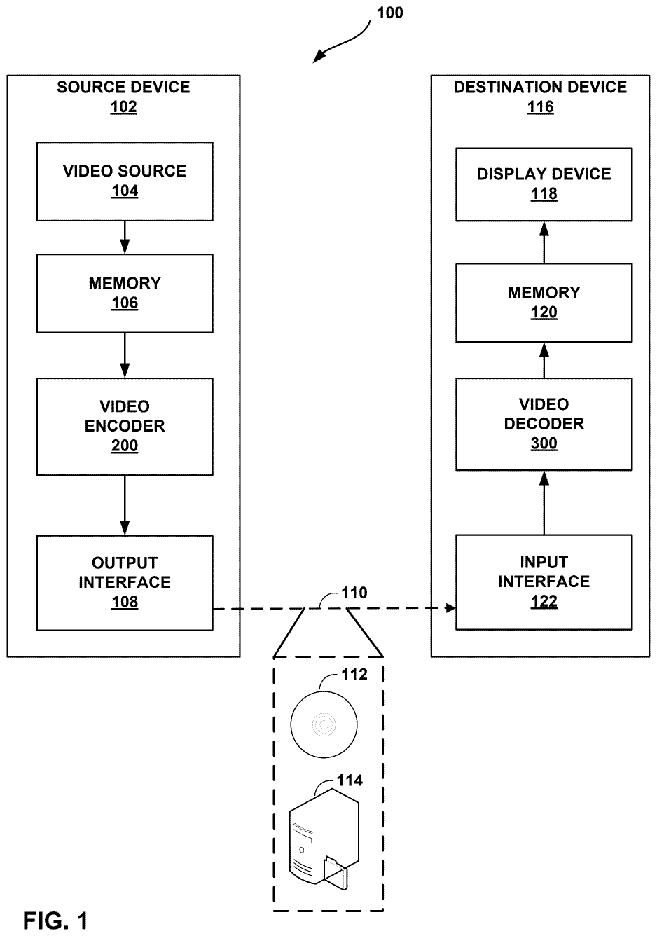

FIG. 1 is a block diagram illustrating an example media encoding and decoding system that may perform the techniques of this disclosure. It should be noted that the techniques of this disclosure are not limited to media encoding and decoding applications, but may be used in any system employing a data network, such as a neural network. In the context of this disclosure, media may include any digital file to be compressed, including video data and/or images. FIG. 1 is generally directed to coding (encoding and/or decoding) video data and/or image data. While examples of FIG. 1 will be described with reference to media encoding and decoding, the techniques of this application are equally applicable to the encoding and decoding of any type of data file using neural-based compression techniques or any other application that uses a neural network.

As shown in FIG. 1, system 100 includes a source device 102 that provides encoded media data to be decoded and displayed by a destination device 116, in this example. In particular, source device 102 provides the media data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for entropy coding a neural-based media compression system. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100, as shown in FIG. 1, is merely one example. In general, any digital media encoding and/or decoding device may perform techniques for entropy coding a neural-based media compression system. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally, or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input interface 122 to video decoder 300. In some examples, portions of memories 106, 120 may be allocated as one or more buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage video such as a hard drive, Blu-ray discs, DVDs, CD-ROMs, flash memory, volatile or non-volatile memory, or any other suitable digital storage video for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both, that is suitable for accessing encoded video data stored on file server 114. Input interface 122 may be configured to operate according to any one or more of the various protocols discussed above for retrieving or receiving video data from file server 114, or other such protocols for retrieving video data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300. Display device 118 displays decoded pictures of the decoded video data to a user. Display device 118 may represent any of a variety of display devices such as a liquid crystal display (LCD), a plasma display, an organic light emitting diode (OLED) display, or another type of display device.

According to the techniques of this disclosure, video encoder 200 or video decoder 300 may include a neural coder. The neural coder may use neural network weights to encode or decode video data. The neural network weights may be compressed/decompressed using the techniques of this disclosure.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (coder) in a respective device. A device including video encoder 200 and/or video decoder 300 may comprise an integrated circuit, a microprocessor, and/or a wireless communication device, such as a cellular telephone.

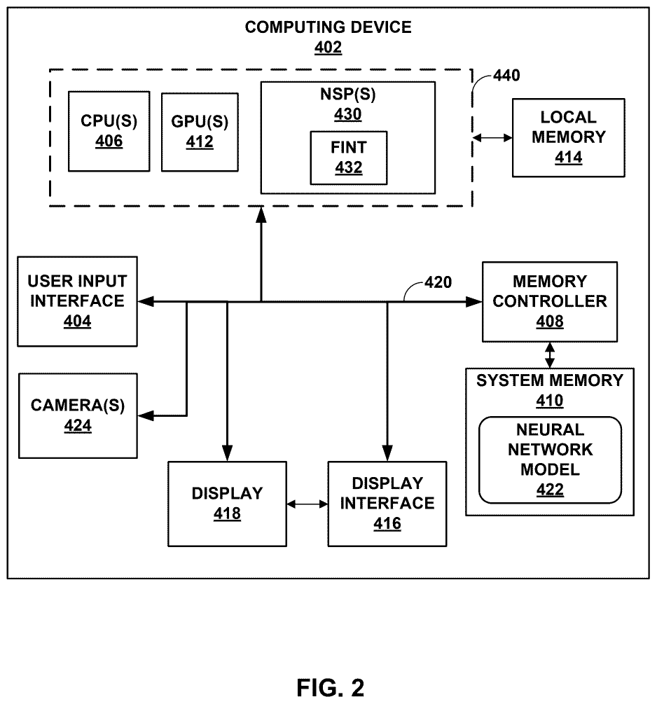

FIG. 2 is a block diagram illustrating an example computing device that may perform techniques of this disclosure. Computing device 402 may comprise a mobile device (such as, e.g., a smart phone, a mobile telephone, a cellular telephone, a satellite telephone, and/or a mobile telephone handset), a personal computer, a desktop computer, a laptop computer, a computer workstation, a video game platform or console, a landline telephone, an Internet telephone, a handheld device such as a portable video game device or a personal digital assistant (PDA), a personal music player, a video player, a display device, a television, a television set-top box, a server, an intermediate network device, a mainframe computer, a mobile computing device, a vehicle head unit, self-driving or autonomous driving vehicle, a robot, or any other type of device having imaging or video capabilities.

As illustrated in the example of FIG. 2, computing device 402 includes a user input interface 404, a CPU(S) 406, a memory controller 408, a system memory 410, a graphics processing unit (GPU) 412, a neural network signal processor (NSP) 430, a Frame Interpolation (FINT) kernel 432, which may be implemented in NSP(S) 430, a local memory 414, a display interface 416, a display 418, bus 420, and one or more cameras 424. User input interface 404, CPU(S) 406, memory controller 408, GPU(S) 412, FINT kernel 432, NSP(S) 430, display interface 416, and one or more cameras 424 may communicate with each other using bus 420. Bus 420 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXentisible Interface (AXI) bus) or another type of bus or device interconnect. It should be noted that the specific configuration of buses and communication interfaces between the different components shown in FIG. 2 is merely exemplary, and other configurations of computing devices and/or other graphics processing systems with the same or different components may be used to implement the techniques of this disclosure.

One or more cameras 424 may include any image capture hardware that includes one or more image sensors and one or more lens, and that is configured to capture at least one frame of image data and to transfer the at least one frame of image data to CPU(S) 406, GPU(S) 412, NSP(S) 430, and/or FINT kernel 432.

CPU(s) 406 may comprise one or more general-purpose and/or special-purpose processors that controls operation of computing device 402. A user may provide input to computing device 402 to cause CPU(s) 406 to execute one or more software applications. The software applications that execute on CPU(s) 406 may include, for example, an operating system, a word processor application, an email application, a spread sheet application, a media player application, a video game application, a graphical user interface application, and/or other programs. The user may provide input to computing device 402 via one or more input devices (not shown) such as a keyboard, a mouse, a microphone, a touch pad or another input device that is coupled to computing device 402 via user input interface 404.

Memory controller 408 facilitates the transfer of data going into and out of system memory 410. For example, memory controller 408 may receive memory read and write commands, and service such commands with respect to system memory 410 in order to provide memory services for the components in computing device 402. Memory controller 408 is communicatively coupled to system memory 410. Although memory controller 408 is illustrated in the example computing device 402 of FIG. 1 as being a processing module that is separate from both CPU(s) 406 and system memory 410, in other examples, some or all of the functionality of memory controller 408 may be implemented on one or both of CPU(s) 406 and system memory 410.

System memory 410 may store program modules and/or instructions that are accessible for execution by CPU(s) 406 and/or data for use by the programs executing on CPU(s) 406. For example, system memory 410 may store user applications and graphics data associated with the applications. System memory 410 may additionally store information for use by and/or generated by other components of computing device 402. For example, system memory 410 may act as a device memory for one or more GPU(s) 412 and may store data to be operated on by GPU(s) 412 as well as data resulting from operations performed by GPU(s) 412. System memory 410 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 410 may include instructions that cause CPU(s) 406, GPU(s) 412, NSP(s) 430, and/or FINT kernel 432 to perform the functions ascribed in this disclosure to CPU(s) 406, GPU(s) 412, NSP(s) 430, and FINT kernel 432. Accordingly, system memory 410 may be a computer-readable storage medium having instructions stored thereon that, when executed, cause one or more processors (e.g., CPU(s) 406, GPU(s) 412, NSP(s) 430, and FINT kernel 432) to perform various functions.

In some examples, system memory 410 is a non-transitory storage medium. The term “non-transitory” indicates that the storage medium is not embodied in a carrier wave or a propagated signal. However, the term “non-transitory” should not be interpreted to mean that system memory 410 is non-movable or that its contents are static. As one example, system memory 410 may be removed from computing device 402, and moved to another device. As another example, memory, substantially similar to system memory 410, may be inserted into computing device 402. In certain examples, a non-transitory storage medium may store data that can, over time, change (e.g., in RAM).

GPU(s) 412 may be configured to perform graphics operations to render one or more graphics primitives to display 418. Thus, when one of the software applications executing on CPU(s) 406 requires graphics processing, CPU(s) 406 may provide graphics commands and graphics data to GPU(s) 412 for rendering to display 418. The graphics commands may include, e.g., drawing commands such as a draw call, GPU state programming commands, memory transfer commands, general-purpose computing commands, kernel execution commands, etc. In some examples, CPU(s) 406 may provide the commands and graphics data to GPU(s) 412 by writing the commands and graphics data to system memory 410, which may be accessed by GPU(s) 412. In some examples, GPU(s) 412 may be further configured to perform general-purpose computing for applications executing on CPU(s) 406.

GPU(s) 412 may, in some instances, be built with a highly parallel structure that provides more efficient processing of vector operations than CPU(s) 406. For example, GPU(s) 412 may include a plurality of processing elements that are configured to operate on multiple vertices or pixels in a parallel manner. The highly parallel nature of GPU(s) 412 may, in some instances, allow GPU(s) 412 to draw graphics images (e.g., GUIs and two-dimensional (2D) and/or three-dimensional (3D) graphics scenes) onto display 418 more quickly than drawing the scenes directly to display 418 using CPU(s) 406. In addition, the highly parallel nature of GPU(s) 412 may allow GPU(s) 412 to process certain types of vector and matrix operations for general-purpose computing applications more quickly than CPU(s) 406. In some examples, computing device 402 may make use of the highly parallel structure of GPU(s) 412 to perform parallel entropy coding.

GPU(s) 412 may, in some instances, be integrated into a motherboard of computing device 402. In other instances, GPU(s) 412 may be present on a graphics card that is installed in a port in the motherboard of computing device 402 or may be otherwise incorporated within a peripheral device configured to interoperate with computing device 402. In further instances, GPU(s) 412 may be located on the same microchip as CPU(s) 406 forming a system on a chip (SoC). GPU(s) 412 and CPU(s) 406 may include one or more processors, such as one or more microprocessors, application specific integrated circuits (ASICs), field programmable gate arrays (FPGAs), digital signal processors (DSPs), or other equivalent integrated or discrete logic circuitry.

CPU(s) 406, GPU(s) 412, NSP(s) 430, and FINT kernel 432 may together be referred to as one or more processors 440. In describing the various techniques that may be performed by one or more processors 440, it should be understood that such techniques may be performed by one or more of CPU(s) 406, GPU(s) 412, NSP(s) 430, and FINT kernel 432. It should be understood that the techniques disclosed herein are not necessarily limited to being performed by CPU(s) 406, GPU(s) 412, NSP(s) 430, and/or FINT kernel 432, but may also be performed by any other suitable hardware, device, logic, circuitry, processing units, and the like of computing device 402.

GPU(s) 412 may be directly coupled to local memory 414. Thus, GPU(s) 412 may read data from and write data to local memory 414 without necessarily using bus 420. In other words, GPU(s) 412 may process data locally using a local storage, instead of off-chip memory. This allows GPU(s) 412 to operate in a more efficient manner by eliminating the need of GPU(s) 412 to read and write data via bus 420, which may experience heavy bus traffic. In some instances, however, GPU(s) 412 may not include a separate cache, but instead utilize system memory 410 via bus 420. Local memory 414 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media.

As described, CPU(s) 406 may offload graphics processing to GPU(s) 412, such as tasks that require massive parallel operations. As one example, graphics processing requires massive parallel operations, and CPU(s) 406 may offload such graphics processing tasks to GPU(s) 412. However, other operations such as matrix operations may also benefit from the parallel processing capabilities of GPU(s) 412. In these examples, CPU(s) 406 may leverage the parallel processing capabilities of GPU(s) 412 to cause GPU(s) 412 to perform non-graphics related operations.

CPU(s) 406, GPU(s) 412, NSP(s) 430, and/or FINT kernel 432 may store rendered image data in a frame buffer that is allocated within system memory 410. Display interface 416 may retrieve the data from the frame buffer and configure display 418 to display the image represented by the rendered image data. In some examples, display interface 416 may include a digital-to-analog converter (DAC) that is configured to convert the digital values retrieved from the frame buffer into an analog signal consumable by display 418. In other examples, display interface 416 may pass the digital values directly to display 418 for processing.

Display 418 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display, an organic light-emitting-diode (OLED) display, or another type of display unit. Display 418 may be integrated within computing device 402. For instance, display 418 may be a screen of a mobile telephone handset or a tablet computer. Alternatively, display 418 may be a stand-alone device coupled to computing device 402 via a wired or wireless communications link. For instance, display 418 may be a computer monitor or flat panel display connected to a personal computer via a cable or wireless link.

System memory may store neural network model 422. Neural network model 422 may include one or more artificial neural networks (also referred to as neural networks) trained to receive input data of one or more types and to, in response, provide output data of one or more types.

A neural network (e.g., neural network model 422) may include a trainable or adaptive algorithm utilizing nodes that define rules. For example, a respective node of a plurality of nodes may utilize a function, such as a non-linear function or if-then rules, to generate an output based on an input. A neural network may include three types of layers of nodes, namely an input layer, one or more hidden layers, and an output layer. The input layer may receive inputs, such as values from which the neural network as a whole generates an output. The output of each node of the input layer may be provided to each node of a first layer of hidden layers. Each input from the input layer may be multiplied by a neural network weight and then summed at each node of hidden layers. Such weights are determined or adjusted during training of neural network to establish a relationship between the input data and output data. Output of each node of the first hidden layer are provided to each node of a next hidden layer, and so on, when there are more than one hidden layer. The output layer may be provided with the output of each node of the last hidden layer. The output layer may include a transfer function and may output an inference, prediction, classification, etc. which is based on the input data and the neural network weights.

A respective node of a plurality of nodes of a layer may be connected to one or more different nodes of the plurality of nodes along an edge, such that the output of the respective node includes the input of the different node. The functions may include neural network weights that may be determined or adjusted using a training set of inputs and desired outputs along with a learning rule, such as a back-propagation learning rule. The back-propagation learning rule may utilize one or more error measurements comparing the desired output to the output produced by the neural network to train the neural network by varying the parameters to minimize the one or more error measurements.

In some examples, neural network model 422 is trained to perform classification of input data. That is, neural network model 422 may be trained to label input data to classify input data into one or more classes or categories. Neural network model 422 may perform classification of input data by determining, for the input data, a confidence score for each of a plurality of classes that indicates a degree to which it is believed that the input data should be classified into the corresponding class. In other examples, neural network model 422 may determine a probabilistic distribution over a set of classes to indicate the probability that the input data belongs to each of the set of classes.

In some examples, neural network model 422 may be trained to perform computer vision tasks such as image classification, object detection, and/or image segmentation. Such computer vision tasks may be useful for computer vision applications such as autonomous driving. For example, neural network model 422 may be trained to perform image classification to determine which objects are in an image or video, such as by being trained to classify an image as either including a particular object or not including the particular object and by assigning one or more labels to the image. In another example, neural network model 422 may be trained to perform object detection to detect what objects are in an image or video and to specify where each of the objects are in the image, and neural network model 422 may be trained to assign one or more labels to each of the one or more objects in the image. In some examples, neural network model 422 may be trained to perform image segmentation to separate an image into regions that delineate potentially meaningful areas for further processing.

In some examples, neural network model 422 may perform one or more computer vision tasks on images captured by one or more cameras 424. That is, one or more cameras 424 may capture an image, and one or more processors 440 may input the image captured by one or more cameras 424 into neural network model 422 to perform one or more computer vision tasks, such as image classification, object detection, and/or image segmentation on the image.

In accordance with one or more aspects of this disclosure, computing device 402 may be configured to: determine a Cartesian grid in a space, wherein the Cartesian grid corresponds to a precision of an arithmetic processing unit; determine, for each of a plurality of neural network weights, a respective vector in the space, such that each respective vector belongs to a corresponding predefined vector on the Cartesian grid and represents a respective compressed neural network weight of a plurality of compressed neural network weights; execute, based on the plurality of compressed network weights, the neural network; and generate, based on executing the neural network, an output.

As discussed above, it may be desirable to compress neural network weights. Compressing neural network weights to integer values when such neural network weights are originally computed as floating-point values is inherently a lossy compression operation.

Some basic strategies that can be used for lossy compression are described in Robert M. Gray and David L. Neuhoff, “Quantization,” IEEE Trans. on Information Theory, vol. 44 (6), pp. 2325-2383, 1998; and Robert M. Gray, “Vector quantization,” IEEE ASSP Magazine, vol. 1 (2), pp. 4-29, 1984 (hereinafter “Gray”). Such strategies include scalar quantization (SQ), followed by entropy coding; VQ only; and VQ followed by entropy coding.

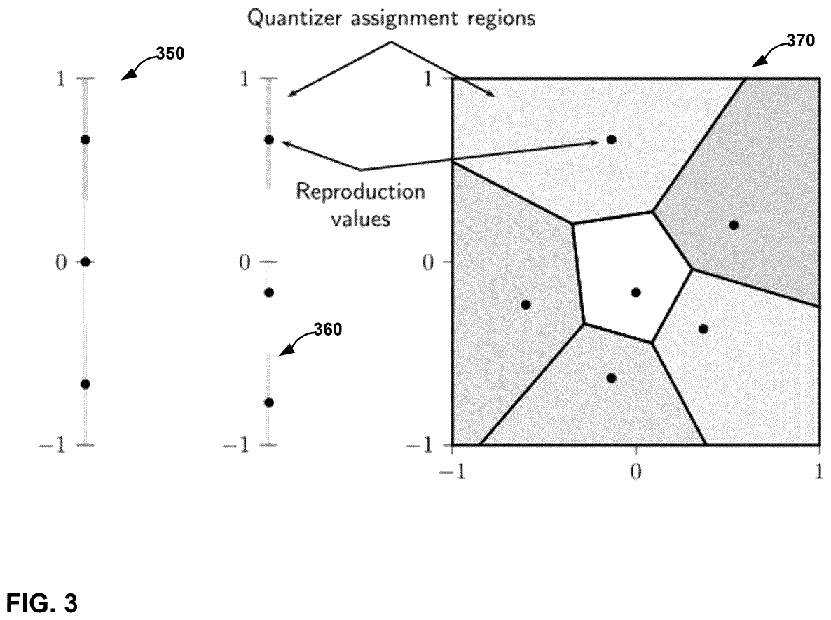

FIG. 3 is a conceptual diagram illustrating example reproduction values and quantizer assignment regions for uniform scalar quantization with M=3, non-uniform scalar quantization with M=3, and vector quantization in a two-dimensional space with N=6. As such, FIG. 3 shows the basic differences between SQ and VQ.

For SQ the range of possible values is divided into M intervals (called assignment regions), each value is encoded by the index m∈{0,1, . . . , M-1} of the interval it belongs to, using log₂ M bits/value (for example, when M=3, log₂ 3≈1.6 bits/value), and represented at the neural network decoder by the reproduction value of the interval. Media applications commonly use the simplest and fastest scalar uniform quantization, which corresponds to uniformly spaced intervals, with reproduction at the middle point, as in example 350 representing a uniform scalar quantization. Depending on the probability density function of the data values, the assignment regions and reproduction value can be defined to minimize the average distortion (commonly squared error), as shown in example 360 representing a non-uniform scalar quantization. Since each index can have a different probability, better compression may be obtained by applying lossless entropy coding to indexes.

VQ, on the other hand, groups values in D-dimensional vectors, splits the space into N quantizer assignment regions, as shown in example 370 representing a vector quantization, and each vector is encoded as the index of the region (shown with different shadings) to which the vector belongs, using at most (log₂ N)/D bits/value ((log₂ 6)/2≈1.3 bits/value in vector quantizer example 370 of FIG. 3), and the neural network decoder may use the centroid of the region to represent the vector. Better compression can be obtained by applying entropy coding to the indexes, but the optimal space partitioning reduces the difference in probability between indexes, making entropy coding less important.

VQ is designed to exploit data distribution, for example, minimizing or reducing an average error by using larger sets for values that have a very low probability, and smaller sets for values with larger probabilities. One fundamental result of Shannon's information theory is that data values can be more efficiently compressed as vectors, even when they are statistically independent.

Uniform scalar quantization is commonly used for highly compressible multimedia data because coding techniques for that type of data are designed to obtain probability distributions with very high peaks. For example, with video data it is common to have more than 95% of the values coded with the same index, and to obtain compression ratios of 100:1. In those cases, entropy coding may be much more effective than VQ.

On the other hand, neural network weights are less compressible than multimedia data, and have probability distributions that can be exploited by VQ techniques, becoming an attractive choice for compression of neural network weights due to the low computational complexity of VQ and easier parallelization.

Compression parallelization is now discussed. Neural network weight compression only makes practical sense if decoding is fast enough to match the throughput of parallelized neural network computations, and if the power needed for decompression is relatively small. Those requirements may be satisfied by using relatively simple and fast compression techniques that can be efficiently parallelized.

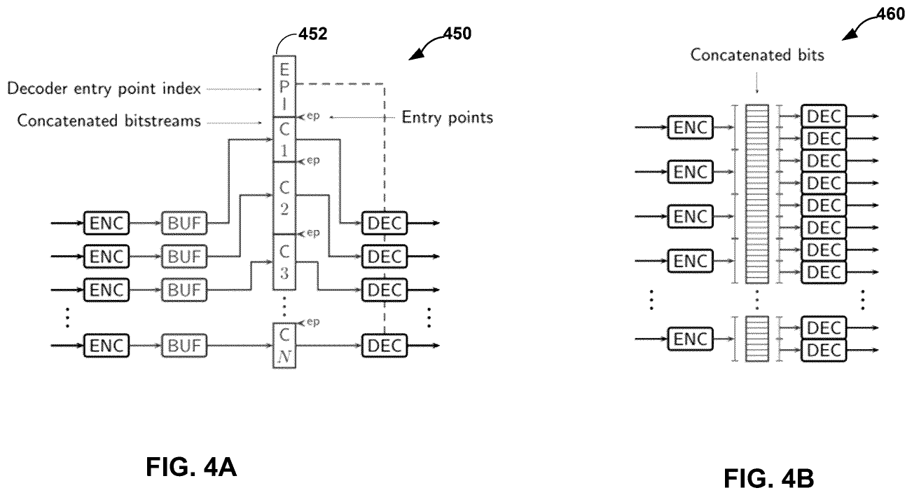

FIG. 4A is a block diagram illustrating an example of entropy coding parallelization using multiple independent bitstreams and a header with decoder entry points. A feature of lossless entropy coding is that lossless entropy coding generates a variable number of compressed data bits depending on the data values, creating significant practical problems for parallelizing lossless entropy coding. Since the compressed data bitstream of lossless entropy coding cannot be effectively randomly accessed, it may be desirable to use schemes as entropy coder 450 shown in FIG. 4A, where parallelization is enabled by generating many independent bitstreams, and adding a header 452 that indicates positions where parallel decoding can start (e.g., decoder entry points). The size of header 452 increases with the number of bitstreams, thus decreasing compression efficiency and constraining parallelization. See, e.g., Amir Said, Hoang Le, and Farzad Farhadzadeh, “Bitstream organization for parallel entropy coding on neural-based video codecs,” IEEE Multimedia Conference, December 2023.

Even with parallel execution, the unpredictable size of compressed data may create several performance bottlenecks. For example, the asynchronous data generation of such parallel execution may only run on the commonly available single-instruction-multiple-data/-thread (SIMD/SIMT) accelerators, using less efficient predicate-based programming, to parallelize conditional execution.

This may be notable in practice because SIMD/SIMT acceleration is particularly efficient and easy to implement, see John L. Hennessy and David A. Patterson, Computer architecture: a quantitative approach, Elsevier, 2011, and for that reason is widely supported within most architectures for parallel computing, like multi-core CPUs, GPUS, and DSPs, see Lucian Codrescu, “Architecture of the Hexagon™ 680 DSP for mobile imaging and computer vision,” In 2015 IEEE Hot Chips 27 Symposium (HCS), pp. 1-26. 2015.

VQ does not present this synchronization problem because, when the same dimension D and number of reproduction vectors Nis used for a sufficiently large number of neural network weights, one may use the same number of log₂ N bits/vector for all compressed data elements. On the other hand, such a practice moves from a variable number of bits to variable expected distortion (decoded value errors), depending on the quantizer region.

Since this VQ property may eliminate basic parallel coding synchronization problems, the VQ property may greatly simplify the development of fast parallel compression. FIG. 4B is a block diagram illustrating an example of vector quantization with a constant bitrate, allowing random access to compressed data, and scalable decoder parallelization after compression. The example vector quantizer 460 of FIG. 4B may provide the following advantages. First, it may be possible to find, in the bitstream, the location of any compressed data element by simply counting the bits used per vector (random-access to compressed data). Second, since vectors are coded independently, it may be possible to choose different types and degrees of parallelization at the encoder and decoder and always use the scheme that is most efficient in the device where it is being computed. Third, the same sequence of operations is needed to code each vector, meaning that one can use SIMD/SIMT accelerators for decoding several vectors simultaneously without predication.

VQ can be an effective technique for compressing neural network weights because VQ matches the properties and compression requirements for compressing neural network weights. However, as discussed hereinafter, VQ should be modified to be used for NN weight compression.

Vector quantization definitions and notation are now discussed. There are several VQ variations for different types of data sources and applications, but one basic general form is described herein before providing details of the neural network weight compression techniques of this disclosure sufficient. In this section, VQ is presented for a general data source, afterwards this disclosure describes why this conventional form of VQ may not be useful for compressing neural network weights, and later this disclosure describes techniques for neural network weight compression.

For example, there may be a sequence of independent and identically distributed (i.i.d.) random data values (x₁, x₂, x₃, . . . ), with each element belonging to a set [symbol] , and for vector quantization those elements are grouped to form D-dimensional vectors x∈ [symbol] ^{D}.

For example, a device can normalize floating-point weights to have [symbol] =[−1, 1]⊂ [symbol] , and [symbol] ^{D} be a hypercube. There are situations when weights are quantized to some intermediate integer representation, and in those cases, there are finite sets like

$$𝒳 = \{ α + \frac{β k}{K} : k = 0 , 1 , … , K - 1 \} .$$

Using [symbol] [symbol] {0, 1, 2, . . . , N-1} to represent the set of valid quantized vector indexes, vector quantization may be completely defined by a pair (q, r) of functions

$$q : {𝒳}^{D} \to 𝒩 , r : 𝒩 \to {ℝ}^{D} , \qquad ( 1 )$$

which correspond, respectively, to the VQ encoder (quantizer) and decoder (dequantizer or reconstruction). The quantized vector after encoding and decoding a vector x is thus

$$\hat{x} = q ( x ) r ( q ( x ) ) . \qquad ( 2 )$$

Following from this definition the vector assignment regions (e.g., identified by the shaded areas of example 370 in FIG. 3) are defined by

$${𝒱}_{i} ( q ) \{ x ∈ {𝒳}^{D} : q ( x ) = i \} , i = 0 , 1 , 2 , … , N - 1 , \qquad ( 3 )$$

and the set of N reproduction vectors (e.g., the dots in example 370 in FIG. 3) is

$$𝒞 ( r ) \{ r ( 0 ) , r ( 1 ) , … , r ( N - 1 ) \} . \qquad ( 4 )$$

Commonly the function r(i) is implemented as a table look-up, the vectors in [symbol] (r) are called code vectors, and the set [symbol] (r) is called a codebook.

Optimization of vector quantizers is now discussed. The definitions above simply define the VQ encoding and decoding process. For practical use, a device may attempt to optimize the two functions (q, r) considering (e.g., based on) the data to be coded and the application.

For different applications, specific distortion functions d: [symbol] ^{D}× [symbol] ^{D}→ [symbol] ₊, meant to measure the degradation caused by the quantizer approximations, may be employed. One example of a distortion function is the class of functions corresponding to p-norms, where the vector distortion measure lₚ(x, y) measuring the difference between vectors x and y, is defined by:

$${l}_{p} ( x , y ) = \sqrt[p]{{\vert {x}_{1} - {y}_{1} \vert}^{p} + {\vert {x}_{2} - {y}_{2} \vert}^{p} + … + {\vert {x}_{D} - {y}_{D} \vert}^{p}} , \qquad ( 5 )$$

and the case p=2, representing the Euclidean distance, is the most studied and used.

The data statistical distribution should also be specified. When set [symbol] is an interval with an infinite set of values (e.g., representing floating-point values), the data statistical distribution may be specified using conditional vector probability density functions f(x|x∈ [symbol] ), which enable computing expected (average) values using D-dimensional integrals in the form of a conditional expectation of a function h(x), represented by

$${E}_{x ∈ 𝒱} [ h ( x ) ] = {\int }_{x ∈ 𝒱} h ( x ) f ( x \vert x ∈ 𝒱 ) dx , \qquad ( 6 )$$

where E_{x∈V}[·] represents the expectation conditioned to x∈ [symbol] and f(x|x∈ [symbol] ) is a conditional probability density function.

When set [symbol] has a finite number of values, discrete conditional probability mass functions may be used instead of eq. (6), and the integral may be replaced by D summations. To simplify the presentation, those cases are implicitly considered together by using this common notation for expected values.

Optimal vector quantization is now discussed. Using those definitions set forth above, an optimal vector quantizer (q*, r*) is defined by the encoder and decoder functions that minimize the expected distortion, e.g.,

$$( {q}^{*} , {r}^{*} ) {arg min}_{q , r} {E}_{x ∈ {𝒳}^{D}} [ d ( x , r ( q ( x ) ) ] . \qquad ( 7 )$$

There is no general closed-form solution to this joint optimization of functions (q, r), but there are two well-defined optimality conditions discussed next, known as Lloyd optimality conditions, that are obtained when one of the two functions is fixed.

The first optimality condition may be a fixed reconstruction function. When dequantization function r is fixed, there may be optimal assignment regions defined by the reproduction vector that minimizes distortion, e.g.,

$${q}^{*} ( x \vert r ) = {arg min}_{i ∈ 𝒥} d ( x , r ( i ) ) , \qquad ( 8 )$$

and the corresponding sets

$${\{ {𝒱}_{i} ( {q}^{*} ) \}}_{i = 0}^{N - 1}$$

defined in eq. (3) are called Voronoi regions or cells (see Gray).

Note that for any vector x, this minimization can be done by simply enumerating all reproduction vectors and finding an index of a vector in set [symbol] (r) that minimizes distortion.

When set [symbol] ^{D} has a finite number of vectors, those values can be pre-computed and stored in a table. However, function q* does not need to be explicitly defined to be used during VQ encoding, since function q*can always be computed using eq. (8).

The second optimality condition may be a fixed quantization function. When quantization function q is fixed, it defines sets

$${\{ {𝒱}_{i} \}}_{i = 0}^{N - 1}$$

according to eq. (3), and the optimal reproduction vectors may be those that minimize the average distortion within each quantizer assignment region [symbol] ᵢ, i.e.,

$${r}^{*} ( i \vert q ) = {arg min}_{c ∈ {ℝ}^{D}} {E}_{x ∈ {𝒱}_{i}} [ d ( x , c ) ] , i = 0 , 1 , 2 , … , N - 1. \qquad ( 9 )$$

In this case the vectors in set [symbol] (r*) are called VQ generalized centroids.

When the Euclidean distance is used to measure distortion (d=l₂),

$${r}^{*} ( i \vert q ) = {arg min}_{c ∈ {ℝ}^{D}} {E}_{x ∈ {𝒱}_{i}} [ ‖ x - c ‖ ] = {E}_{x ∈ {𝒱}_{i}} [ x ] , i = 0 , 1 , 2 , … , N - 1 , \qquad ( 10 )$$

which means that in this case [symbol] (r*) contains vectors corresponding to the conventional definition of centroids.

Vector quantization optimization algorithms are now discussed. It should be noted that optimality conditions defined by eqs. (8) and (9) may be necessary but not sufficient, meaning that one can find (q, r) that satisfy those conditions, but that are different from the actual optimal solution defined by eq. (7).

One practical difficulty in optimizing VQ is how to process sets [symbol] ^{D} and Vᵢ when such sets are volumes in multi-dimensional spaces with complicated shapes, and how to efficiently compute the corresponding volumetric integrals in eq. (6).

A general solution is to approximate the VQ problem using only a certain number of vectors sampled from [symbol] ^{D}, forming the training set [symbol] ⊂ [symbol] ^{D} with an integer number of elements, use similarly constrained sets [symbol] ⊂ [symbol] , and a modified quantization function \tilde{q}: [symbol] → [symbol] . With those modifications all sets can be represented and processed using tables, which can be directly used by the optimization algorithm.

VQ optimization techniques are mostly based on using iterative methods that converge to a local solution satisfying equations (8) and (9). For example, when using a training set, one can employ the following generalized Lloyd algorithm to search for optimal VQ functions (see Gray), as follows: initialize codebook r(i) using random vectors, or some heuristic technique for estimating good solutions; and repeat the following iterations to sequentially update \tilde{q} and r:

Use current r in eq. (8) to update \tilde{q} and sets

$${\{ {\tilde{𝒱}}_{ι} \}}_{i = 0}^{N - 1} .$$

Use current sets

$${\{ {\tilde{𝒱}}_{i} \}}_{i = 0}^{N - 1}$$

in eq. (9) to update r.

Stop if the decrease in solution value [symbol] [d(x,r(\tilde{q}(x))] is below a pre-defined threshold.

The final codebook [symbol] (r) may be used in the practical application, together with eq. (8) to define the set q(x) for all vectors x, including those outside the training set [symbol] .

In the communications and information theory communities this iterative solution approach is also known as the Linde-Buzo-Gray (LBG) algorithm, and in the pattern recognition community as the k-means algorithm. Heuristic modifications can be added to avoid local minima and obtain better solutions, but such modifications are not further described herein.

Reduced-complexity vector quantization is now discussed. Many techniques have been developed to increase the efficiency of VQ. See, e.g., A. Vasuki, and P. T. Vanathi, “A review of vector quantization techniques,” IEEE Potentials, vol. 25 (4), pp. 39-47, 2006 (hereinafter “Vasuki”), for a summary of such techniques.

The present disclosure focuses on a major requirement for neural network weight compression, which is very fast decoding.

A fundamental problem in the practical application of VQ is that its effectiveness increases with vector dimension D, but for a desired bitrate of R bits/value the required number of code vectors grows exponentially with D, since

$$R = \frac{{log}_{2} N}{D} ⇒ N = {2}^{D R} . \qquad ( 11 )$$

This means that the amount of memory required to store code vectors can quickly become prohibitively large, and that practical applications of VQ are constrained by memory costs. This also affects decoding times because memory costs quickly increase with memory speed.

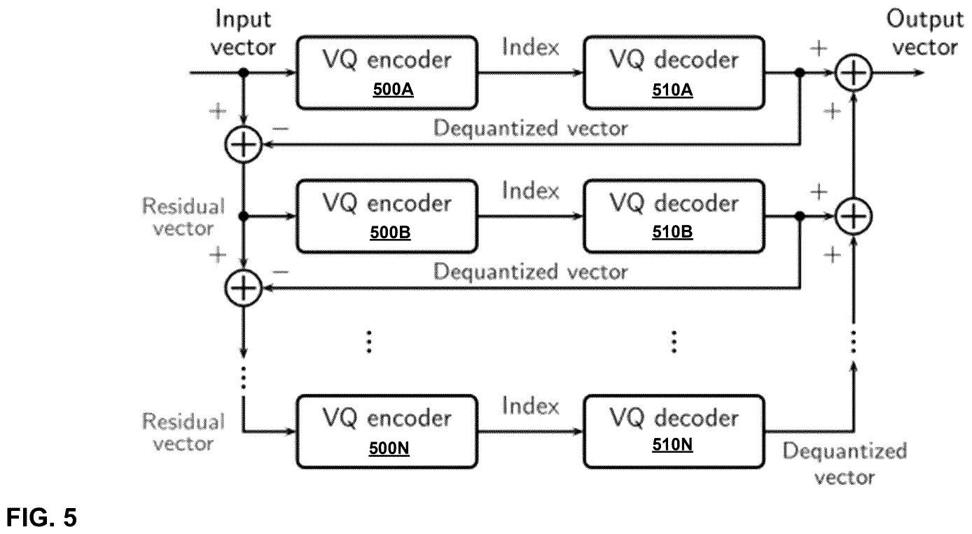

An effective approach to reduce memory is to decompose the VQ compression into more than one table look-up stage, so that the total memory is the sum of table sizes, but the total number of possible code vectors is the product of the sizes (if there are no duplications). FIG. 5 is a block diagram illustrating an example of multi-stage residual vector quantization for codebook memory reduction. Residual VQ, shown in FIG. 5, was developed using such an approach. See, e.g., Vasuki; and Christopher F. Barnes, Syed A. Rizvi, and Nasser M. Nasrabadi, “Advances in residual vector quantization: A review,” IEEE Transactions on Image Processing, vol. 5 (2), pp. 226-262, 1996.

There are also VQ product codes designed for complexity reduction (see, e.g., Gray, and see P. T. Vanathi, “A review of vector quantization techniques,” IEEE Potentials, vol. 25 (4), pp. 39-47, 2006), like the gain-shape quantizers, but such VQ product codecs are best fused or joint compression of different data types, and not the distribution commonly found for NN weights.

VQ definition mismatch is now discussed. In the conventional definition of the VQ functions in eq. (1), there are no constraints on the elements of the code vectors, and the optimal values of the elements are defined indirectly, from the data statistical distribution and distortion function, by the optimization in eq. (7). However, as explained above, the purpose of neural network weight quantization is to allow matrix arithmetic operations using only low precision integers. For a K-bit integer representation, each matrix element, e.g., each network weight W, may satisfy

$$W ∈ {ℕ}_{K} \{ 0 , 1 , 2 , … , {2}^{K} - 1 \} . \qquad ( 12 )$$

When the number of bits K is sufficiently large, it may be possible to obtain good VQ solutions with integer vector elements simply by scaling and rounding the elements of a VQ codebook, which can be designed using the techniques described above.

However, since a requirement for neural network weight compression may be to have a small number of precision bits K, and the VQ optimization problem may have to be redefined in a non-trivial manner, to guarantee that all VQ code vectors belong to the Cartesian grid defined by eq. (12).

Memory reduction is now discussed. When VQ was first used, the memory required for code vector tables was expensive, but very fast compared to the processing circuitry. Thus, memory reduction techniques, as described above, were designed to avoid processing, and relied mostly on the fast memory access.

Current data storage technologies provide many different types of memory, ranging from inexpensive but relatively slow to much faster and expensive, with costs rising very rapidly with speed. For this reason, new processor architectures use complex hierarchical memory caches, and overall speed depends on data access patterns.

Independently of implementations details, there are trends worth noting: (a) in applications where high throughput is needed, like neural network weight compression, it may be highly desirable to minimize memory and keep all data in a fast cache; and (b) compared to memory access, parallel data processing became less expensive and sufficiently fast, enabling more complex techniques for memory reduction.

An additional problem is that past techniques for memory reduction (e.g., multi-stage VQ of FIG. 5) are not suitable for the integer VQ constraints discussed above. In conclusion, new memory reduction techniques, that can exploit fast parallel processing and satisfy the constraints of eq. (12), should be developed.

According to the techniques of this disclosure, computing device 402 may utilize a modified VQ definition modified for neural network weight compression, For example, computing device 402 may utilize Cartesian grid constrained vector quantization (CGC-VQ).

For example, the definition of VQ described above may be modified for NN weight compression to include the constraints in eq. (12), but instead of using exactly those constraints, computing device 402 may use a formulation that may be viewed as mathematically equivalent, but more convenient during optimization.

Neural networks are mostly designed, trained, and evaluated using floating-point neural network weight representations, and in the final deployment those weights are quantized to integer values. For that reason, when optimizing VQ for neural network weight compression it is convenient to maintain the scaling and normalizations used for floating-point values to compute the VQ distortion.

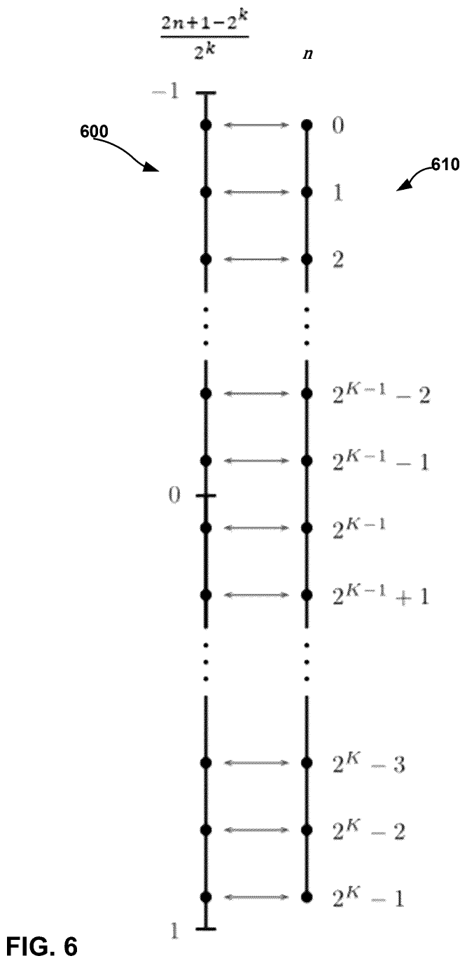

This can be done by generalizing the constraints defined by eq. (12) to affine transformations of integer values. FIG. 6 is a conceptual diagram illustrating an example mapping from integer matrix elements 610 to neural network weights 600 normalized to an interval of [−1,1]. For example, when the floating-point weight normalization is w∈[−1,1], one can consider the set of integer values scaled to the same interval, and assume that dequantized K-bit weights must belong to the following set (with mapping shown in FIG. 6).

$$w ∈ {𝒩}_{K} \{ \frac{2 n + 1 - {2}^{K}}{{2}^{K}} : n = 0 , 1 , 2 , … , {2}^{K} - 1 \} . \qquad ( 13 )$$

More generally, for a given output set [symbol] with finite cardinality (number of set elements), one can define a new type of constrained VQ, which may be referred to as CGC-VQ, using a new pair (q, s) of functions

$$q : {𝒳}^{D} \to N , s : 𝒩 \to {𝒲}^{D} . \qquad ( 14 )$$

This modification is notable because when optimal CGC-VQ functions are defined as

$$( {q}^{*} , {s}^{*} ) {arg min}_{q , s} {E}_{x ∈ {𝒳}^{D}} [ d ( x , s ( q ( x ) ) ] , \qquad ( 15 )$$

the optimality condition corresponding to eq. (8) is still valid, but the optimality condition corresponding to eq. (9) is not, because the CGC-VQ code vectors belong to the Cartesian grid [symbol] ^{D}, e.g., code vectors cannot be modified in a continuous manner.

In other words, since CGC-VQ code vectors belong to a grid of M=| [symbol] ^{D}| predefined vectors, a main optimization problem is the selection within that grid of the optimal set of N code vectors. This optimal set of code vectors [symbol] * is thus defined as the subset selection that minimizes the expected distortion, i.e.,

$${ℬ}^{*} = {arg min}_{ℬ ⊂ {𝒲}^{D} , \vert ℬ \vert = N} {\int }_{x ∈ {𝒳}^{D}} f ( x ) {min}_{c ∈ 𝒞} d ( x , c ) dx . \qquad ( 16 )$$

This is a very significant change because continuous VQ optimization can employ efficient solution techniques based on gradients. For some important cases, the solution can even be derived analytically, like the centroid computation defined by eq. (10) when the Euclidian distance is used as distortion measure.

For example, computing device 402 may determine an expected distortion measure.

Discrete optimization problems, on the other hand, are in general much more difficult to solve. In fact, as explained in the next section, eq. (16) corresponds to a well-known type of location optimization on weighted graphs called the p-median problem, see, e.g., Michael B. Teitz and Polly Bart, “Heuristic methods for estimating the generalized vertex median of a weighted graph,” Operations Research, vol. 16 (5), pp. 955-961, 1968 (hereinafter “Teitz”); and O. Kariv and S. L. Hakimi, “An algorithmic approach to network location problems. II: the p-medians,” SIAM Journal on Applied Mathematics, vol. 37 (3), pp. 539-560, December 1979 (hereinafter “Kariv”), which is known to belong to the class of NP-hard combinatorial problems.

Thus, in general the CGC-VQ optimization problem can exactly be solved by evaluating the expected distortion of all M!/[N!×(M−N)!] possible code vector selections, which can be prohibitively large even for small problems. For example, if M=64 and N=48, then device 402 may need to evaluate the expected distortion of about 5×10¹⁴ selections.

However, while it can be computationally extremely expensive to find a solution that is guaranteed to be optimal, it has been found that in practice it is much easier to find, using heuristic techniques, solutions that are reasonably near the optimal. This disclosure describes in the next sections adapting heuristic techniques for CGC-VQ codebook optimization.

Conversion to graph model is now discussed. The p-median problem is a well-known mathematical optimization model for selecting, in a weighted graph with V+C vertices, P median vertices from a set of C median candidate vertices. See, e.g., Teitz; and Kariv. In a common practical application, the V vertices may represent customer locations, and the P median vertices may represent facilities that are going to be installed to supply those customers, with median locations chosen to minimize the sum of transportation costs from each customer to the nearest facility. In this section this disclosure describes how such an application may be equivalent to CGC-VQ codebook optimization.

For example, computing device 402 may calculate a p-median to optimize a codebook associated with the plurality of compressed neural network weights by minimizing the expected distortion measure.

One main practical problem in solving the optimization of eq. (16) is the computation of the integrals for determining the expected distortion of each solution. Those integrals can only be directly computed for some very special cases, and as explained in above, conventional VQ optimization algorithms commonly work with a discrete training set [symbol] ⊂ [symbol] ^{D}, that contains samples from the random distribution of weight values.

With that approach, the integrals needed for computing the average distortion may be replaced by sums over the elements of training set [symbol] . In fact, using random or pseudo-random vectors for the training set may correspond to a type of Monte Carlo numerical integration. See William H. Press et al., Numerical recipes: The art of scientific computing, 3rd ed. Cambridge University Press, 2007 (hereinafter “Press”). However, as discussed in the next section, there are similar but better techniques to estimate those integrals, and such techniques use a modified expected distortion measure

$$\overline{d} ( x , c ) p ( x ) d ( x , c ) , x ∈ 𝒯 , \qquad ( 17 )$$

where p(x) is a probability or weight assigned to each element of the training set.

Using this modified expected distortion measure, the CGC-VQ optimization may be defined as the problem of selecting N elements of grid [symbol] ^{D} that minimize the expected reproduction distortion

$${𝒞}^{*} = {arg min}_{𝒞 ⊂ {𝒲}^{D} , \vert 𝒞 \vert = N} {\sum }_{x ∈ 𝒯} {min}_{c ∈ 𝒞} \overline{d} ( x , c ) . \qquad ( 18 )$$

With the CGC-VQ optimization defined by eq. (18), the CGC-VQ optimization can be directly converted to a p-median problem on a graph. For example, one may represent the M grid vectors w∈ [symbol] ^{D} as median candidate vertices, the T vectors x∈ [symbol] as customer vertices, and define a bipartite graph where edges connect vertices in those two sets, and each vertex has weight equal to the expected distortion d̅(x, w) that occurs when vector x is reproduced using vector w.

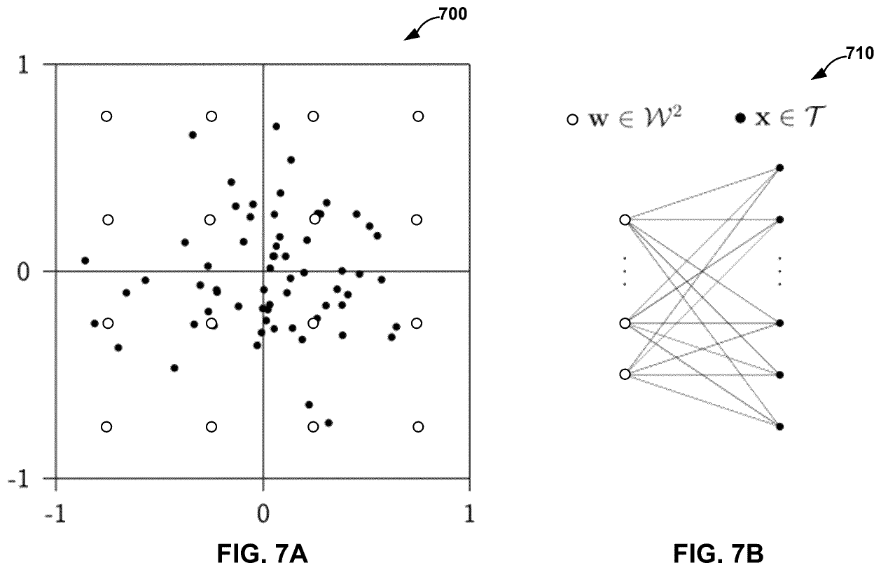

FIG. 7A is a graphical diagram illustrating an example of two-dimensional CGC-VQ problem with code vector candidates and vectors from a training set. FIG. 7B is a graphical diagram illustrating an example graph for p-median problem formulation.

CGC-VQ space 700 is defined for 2-bit integer weights, where the open circles represent the grid of equally spaced discrete values for quantized weights, e.g., those values that can be code vectors (w∈ [symbol] ²), while dots represent the floating-point values in the training set (x∈ [symbol] ⊂ [symbol] ²). The corresponding bipartite graph 710 for the median optimization problem is shown in FIG. 7B.

With this graph model, choosing from the candidate set the N median vertices that minimize edge costs may be viewed as mathematically the same as selecting the N code vectors from the grid [symbol] ^{D} to form a codebook [symbol] *⊂ [symbol] ^{D} that minimizes the expected distortion.

Heuristic CGC-VQ optimization is now described. Since the optimization problem defined by eq. (18) matches the most common formulation of the p-median problem, the algorithms developed for solving that problem can be used for CGC-VQ optimization. Sec, e.g., Teitz; Kariv; Paul J. Densham and Gerard Rushton, “Strategies for solving large location-allocation problems by heuristic methods,” Environment and Planning A, vol. 24 (2), pp. 289-304, 1992 (hereinafter “Densham”); Erik Rolland, David A. Schilling, and John R. Current, “An efficient tabu search procedure for the p-median problem,” European Journal of Operational Research, vol. 96 (2), pp. 329-342, 1997 (hereinafter “Rolland”); Mauricio G. C. Resende and Renato F. Werneck, “A hybrid heuristic for the p-median problem,” Journal of Heuristics, vol. 10, pp. 59-88, 2004; and Nenad Mladenović, Jack Brimberg, Pierre Hansen, and José A. Moreno-Pérez, “The p-median problem: a survey of metaheuristic approaches,” European Journal of Operational Research, vol. 179 (3), pp. 927-939, 2007.

How to adapt heuristic approaches to exploit some VQ properties is now discussed. One approach that has been shown to be efficient and relatively simple to implement is to use the median vertex replacement heuristic (see Teitz), where the costs of replacing a median vertex by a non-median candidate vertex is computed at each iteration, and the replacement with smallest distortion is performed.

To avoid local minima, median replacement can be combined with the Tabu Search technique (see Rolland), that employs two “tabu” FIFO (first-in first-out) fixed-size lists with vertices that are temporarily forbidden to be selected and deselected as median vertices. The newly selected medians are added to the deselection tabu list, and cannot be removed while in that list, and similarly the removed medians are added to the selection tabu list and cannot be selected again while in that list.

With this combination, in each iteration the best replacement allowed by the tabu lists may be performed even when the overall distortion increases, but this allows the search algorithm to “escape” from local minima, and to eventually find better solutions. The search algorithm may end after a predefined number of iterations (replacements), and the search algorithm can be restarted several times with new random initial solutions.

Below this disclosure describes techniques to reduce the complexity of evaluating cost changes with vertex exchanges, which may be needed for each search iteration. The notation from above is maintained for this discussion, assigning indexes to:

$${𝒲}^{D} = {\{ {w}_{m} \}}_{m = 1}^{M}$$

is the set of all possible codebook vectors in the Cartesian grid.

$$𝒞 = {\{ {c}_{i} \}}_{i = 1}^{N}$$

is the set of vectors currently chosen for CGC-VQ codebook (solution medians in the p-median formulation).

[symbol] ⊂ [symbol] is the median tabu list, e.g., vectors that cannot be removed from the median set.

$$𝒜 = {\{ {a}_{j} \}}_{j = 1}^{A}$$

is the set of codebook candidate vectors (median candidates).

[symbol] ⊂ [symbol] is the candidate tabu list, i.e., vectors that cannot be added to the median set.

$$𝒯 = {\{ {x}_{t} \}}_{t = 1}^{T}$$

corresponds to the training set.

Note that besides those definitions, an additional equation is set forth that

$$N + A = M , 𝒞 ⋃ 𝒜 = {𝒲}^{D} . \qquad ( 19 )$$

Furthermore, since the training set is chosen to approximate an integral as in eq. (16), it is common that T>>M, and thus operations on the training set dominate the computational complexity.

The vertex substitution procedure consists of choosing cᵣ ∈ [symbol] - [symbol] and aₛ ∈ [symbol] - [symbol] and creating a new solution such that

$$𝒞 ← 𝒞 ⋃ \{ {a}_{s} \} - \{ {c}_{r} \} , 𝒜 ← 𝒜 ⋃ \{ {c}_{r} \} - \{ {a}_{s} \} , \qquad ( 20 )$$

$$and$$

$$\breve{𝒞} ← \breve{𝒞} ⋃ \{ {a}_{s} \} - \{ {c}_{r} \} , \breve{𝒜} ← \breve{𝒜} ⋃ \{ {c}_{r} \} - \{ {a}_{g} \} , \qquad ( 21 )$$

where c_{f} ∈ [symbol] and a_{g} ∈ [symbol] are the first elements in the respective tabu lists, according to the FIFO criterion. Since the tabu lists are relatively very small, to simplify the notation they are not included in the following discussions about computation complexity.

A straightforward implementation of this search technique may require evaluating the (M−N)×N possible median replacements, and in each case using T×N operations for evaluating distortion changes in T training set vectors, with total complexity O(T×[M−N]×N²) per iteration.

The vertex replacement algorithm can be accelerated by maintaining, for each solution, the best and second-best codeword assignment for each vector in the training set. See Densham. When this data is available, computing device 402 can use the fact that for single vertex replacements each vector in the training set can only be reassigned to the candidate new median or its second-best assignment.

If one defines the indexes and cost functions of those assignments as

$${s}_{t}^{( 1 )} = {arg min}_{i = 1 , … , N} \overline{d} ( {x}_{t} , {c}_{i} ) , {d}_{t}^{( 1 )} = \overline{d} ( {x}_{t} , {c}_{{s}_{t}^{( 1 )}} ) , \qquad ( 22 )$$

$$and$$

$${s}_{t}^{( 2 )} = {arg min}_{i = 1 , … , N , i \neq {s}_{t}^{( 1 )}} \overline{d} ( {x}_{t} , {c}_{i} ) , {d}_{t}^{( 2 )} = \overline{d} ( {x}_{t} , {c}_{{s}_{t}^{( 2 )}} ) . \qquad ( 23 )$$

and defines

$${d}_{t , j} = \overline{d} ( {x}_{t} , {a}_{j} ) , \qquad ( 24 )$$

then the change Δ_{i,j} resulting from replacing median cᵢ with candidate aⱼ can be computed as

$${Δ}_{i , j} = {\sum }_{t = 1}^{T} \{ \begin{matrix}min ( {d}_{t}^{( 2 )} , {d}_{t , j} ) - {d}_{t}^{( 1 )} , {s}_{t}^{( 1 )} = i , \\ min ( {d}_{t}^{( 1 )} , {d}_{t , j} ) - {d}_{t}^{( 1 )} , {s}_{t}^{( 1 )} \neq i\end{matrix} , \qquad ( 25 )$$

and the (r, s) pair not in the exclusion tabu list [symbol] , that minimizes cost change

$$( r , s ) = {arg min}_{( i , j ) ∉ ℒ} {Δ}_{i , j} , \qquad ( 26 )$$

is used for vertex replacement in eqs. (20) and (21).

One can observe that eq. (25) reduces the computational complexity per iteration from O(T×[M−N]×N²) to O(T×[M−N]×N) operations, while the average complexity to update the list of best and second-best assignments is O(T).

Next, one can extend the idea of maintaining best and second-best assignments, and to reduce complexity use arrays to accumulate changes in the cost function, and determine best substitution based on those array values. For example, on may use the following factorization of eq. (25)

$${Δ}_{i , j} = {ϕ}_{j} + {θ}_{i} + {δ}_{i , j} , \qquad ( 27 )$$

$$where$$

$${ϕ}_{j} = {\sum }_{t = 1}^{T} min ( 0 , {d}_{t , j} - {d}_{t}^{( 1 )} ) , \qquad ( 28 )$$

$${θ}_{i} = {\sum }_{t = 1}^{T} \{ \begin{matrix}{d}_{t}^{( 2 )} - {d}_{t}^{( 1 )} , & {s}_{t}^{( 1 )} = i , \\ 0 & {s}_{t}^{( 1 )} \neq i\end{matrix} , \qquad ( 29 )$$

$$and$$

$${δ}_{i , j} = {\sum }_{t = 1}^{T} \{ \begin{matrix}{d}_{t}^{( 1 )} - {d}_{t}^{( 2 )} , & {s}_{t}^{( 1 )} = i , {d}_{t , j} < {d}_{t}^{( 1 )} , \\ {d}_{t , j} - {d}_{t}^{( 2 )} , & {s}_{t}^{( 1 )} = i , {d}_{t}^{( 1 )} \leq {d}_{t , j} < {d}_{t}^{( 2 )} , \\ 0 , & otherwise\end{matrix} . \qquad ( 30 )$$

Advantages of this factorization are that one-dimensional arrays φⱼ and θᵢ can be initially computed and updated (after each median exchange) with low complexity, and most computations are needed for determining two-dimensional array δ_{i,j}, but the two-dimensional array δ_{i,j} is expected to be very sparse.

In general, complexity may be reduced by initializing the sums to zero, enumerating vectors in the training set, and cumulatively adding term to δ_{i,j}. Three example approaches are set forth below, with varying computation and memory requirements.

The first example approach is a low-memory evaluation. To reduce memory requirements, it is possible to compute d̅(x, a) only when needed, instead of storing values in memory. It is also possible to avoid storing all δ_{i,j} values in memory by generating each row j at a time. For example, computing device 402 may, as part of calculating the p-median, not store the expected distortion measure in one or more memories and not store two-dimensional array values in one or more memories.

This may be accomplished by sequentially fixing j=1, 2, . . . , A, initializing the values of δ_{i,j} with zeros, and updating the row element s while enumerating all values of t in eq. (27). After row δ_{i,j} is fully computed, row δ_{i,j} can be used for updating the selection of best replacement pair of eq. (26). This reduces the complexity from O(T×N×[M−N]) to O([T+N]×[M−N]) operations per iteration.

The second example approach is sorted median candidates. One important property of factorization (27) is that factors in eq. (30) are all zero when

$${d}_{t , j} \geq {d}_{t}^{( 2 )} .$$

This means that if computing device 402 sorts, for each test vector index t, median candidates with indexes j with increasing d_{t,j}, then the loop for the accumulation of δ_{i,j} can stop when

$${d}_{t , j} \geq {d}_{t}^{( 2 )}$$

is satisfied.

Defining an array of sorting indexes π[t, m] such that

$$m \leq n ⇒ \overline{d} ( {x}_{t} , {w}_{π [ t , m ]} ) \leq \overline{d} ( {x}_{t} , {w}_{π [ t , n ]} ) , \qquad ( 31 )$$

an efficient algorithm for computing δ_{i,j} can be defined as
Set δ_{i,j} ← 0, for i = 1, 2, ... , N and j = 1, 2, ... , A;
For t = 1, 2, ... , T
$For m = 1 , 2 , ⋯ , M , and while \overline{d} ( {x}_{t} , {w}_{π [ t , m ]} ) < {d}_{t}^{( 2 )}$
If w_{π[t,m]} = aⱼ ∈ [symbol] then increment δ_{i,j} according to eq. (30).

Sorting indexes according to d_{t,j} needs to be done only once, requiring T×M memory elements that can be computed with complexity O(T×M×log (M)). Using R̅ to represent an average number of candidates that are in the range

$${d}_{t , j} < {d}_{t}^{( 2 )} ,$$

the computational complexity is reduced to O(T×R̅+[M−N]×N) operations per iteration. For example, computing device 402 may sort an index according to a distortion measure a single time.

The third example approach is partially sorted media candidates. Since the size of multidimensional training set grows exponentially with the number of dimensions D, the amount of memory for storing index array π[t, m] can be large, and random access to those arrays can slow down the execution. However, most of the reduction in complexity comes from not visiting the many median candidates that are expected to be “far” from the training-set vector

$$( i . e , \overline{d} ( {x}_{t} , {a}_{j} ) > {d}_{t}^{( 2 )} ) .$$

A similar acceleration is possible if median candidates are partially sorted during computations. In the CGC-VQ optimization, computing device 402 may exploit the structure of the Cartesian grid to visit candidate median vectors in increasingly larger grid “shells,” so that it is possible to guarantee that a candidate median in remaining shells must satisfy

$$\overline{d} ( {x}_{t} , {a}_{j} ) > {d}_{t}^{( 2 )} ,$$

and thus do not need to be considered.

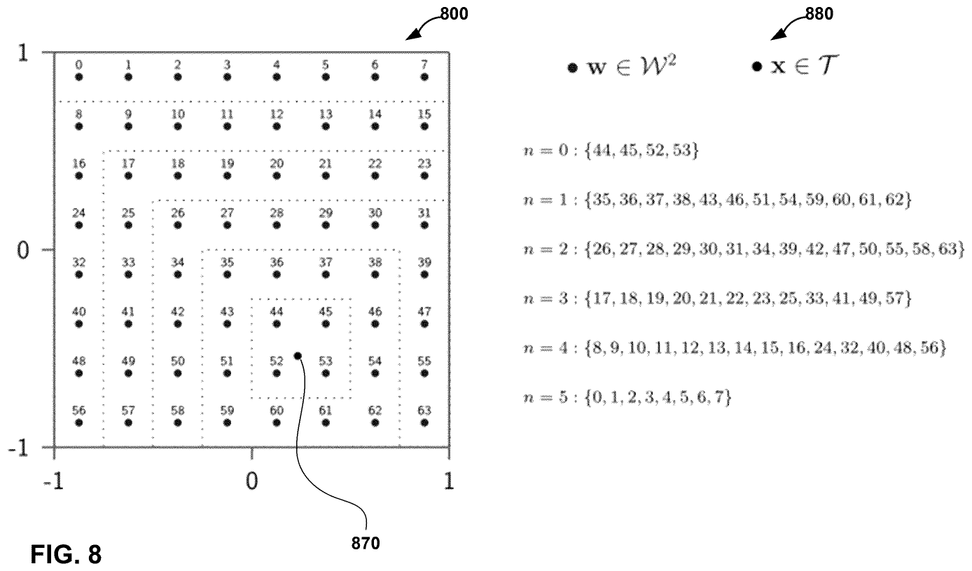

FIG. 8 is a block diagram illustrating an example system for implementing procedural multi-stage CGC-VQ, with exponential reduction of codebook memory requirements according to one or more aspects of this disclosure. In the example of FIG. 8, CGC-VQ space 800 includes a plurality of shells indicated by the dotted lines and x point 870. Scanned vectors 880 are also depicted. It is relatively easy and efficient to generate candidate medians around a training-set vector xₜcd ∈ [symbol] by using simple rounding operations, and loops, as shown in the example of FIG. 8. Using [symbol] (xₜ, n) to represent the grid elements in each shell, it is assumed that, for a given distortion function, there is a lower bound

$$L ( {x}_{t} , n ) \leq {min}_{w ∈ 𝒮 ( {x}_{t} , n )} \overline{d} ( {x}_{t} , w ) . \qquad ( 32 )$$

Using this bound, the median-candidate evaluation can be done for increasing values of n, and then stop when

$$L ( {x}_{t} , n ) \geq {d}_{t}^{( 2 )} .$$

Computing device 402 may iteratively scan for a plurality of median candidates based on groups of training set vector coordinates with increasing lower bounds on the expected distortion measure and exclude a median candidate of the plurality of median candidates from consideration based on a distortion measure of the median candidate being greater than a predetermined distortion measure.

Efficient training set generation is now discussed. A fundamental stage in p-median optimization algorithms is the computation of cost, such as the expected CGC-VQ distortion. The training sets obtained with random samples enables approximating the distortion integrals in eqs. (15) and (16) with sums, and thus corresponds to a form of Monte Carlo integration. For that reason, techniques designed for improving that integration technique are useful for reducing the complexity of CGC-VQ optimization.

One notable observation is that the distortion integrals are used within the integer optimization problem defined in the previous section, which is expected to require many iterations to find a good solution. Thus, a good solution strategy is to use coarser and faster estimations at the initial stages of the optimization, and more precise estimations at the final stages.

Another important aspect is that, with a truly random training set, the error of the multi-dimensional integral approximations has variance that decreases with only order o(1/\sqrt{T}). For that reason, it is better to define a parameterized probability model for the weight's distribution, and then employ the model in more efficient integration techniques.

One such technique is to replace pseudo-random sample generators with low-discrepancy, quasi-random training set generators, using for example, Sobol sequences. See Press. This integration technique is similar to Monte Carlo integration, but with error variance decreasing with order o (1/T). For example, computing device 402 may process a quasi-random training data set. In some examples, the quasi-random training data set is based on at least one Sobol sequence.

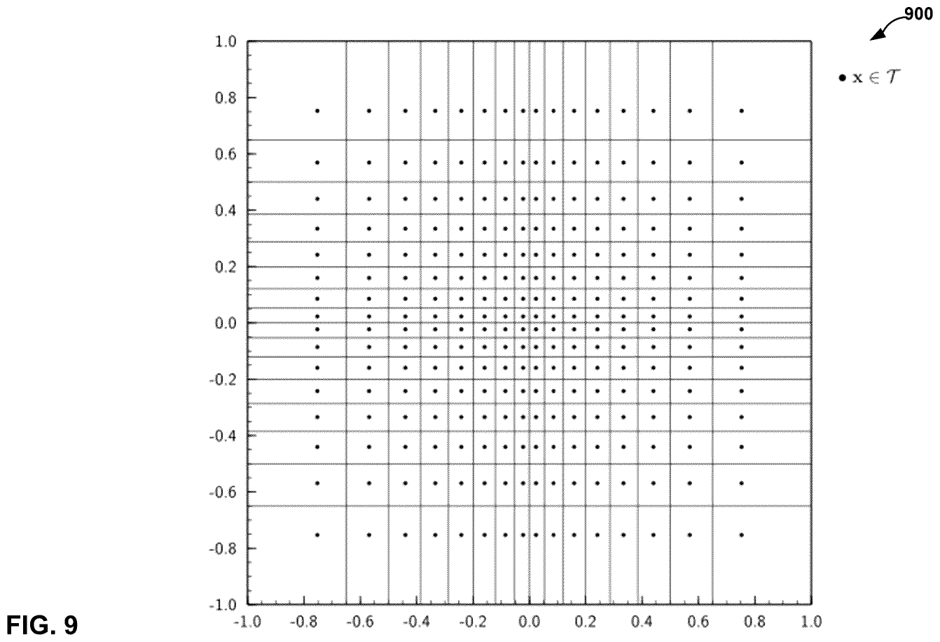

FIG. 9 is a graphical diagram illustrating an example of separable non-uniform quantization to generate training sets, enabling average probabilities and expected distortions to be pre-computed from probability distribution models. Another technique is to apply separable non-uniform scalar quantization, as shown in example 900, and use the centroids as training set (x∈ [symbol] ), but scale the distortion function by a probability measure as in eq. (17). This probability can be pre-computed from the distribution defined by the data model and does not need to be updated during optimization.

For example, computing device 402 may apply separable non-uniform scalar quantization to input data to determine a plurality of centroids. The non-uniform scalar quantization may be based on a probability measure. Computing device 402 may use the plurality of centroids as training data.

Multiple procedural CGC-VQ stages is now discussed. For example, computing device 402 may implement multiple procedural CGC-VQ stages. As explained above, a main problem with VQ is the exponential growth in memory requirements, and for conventional VQ the problem can be addressed by decomposing the coding process with residual vector quantization, as shown in FIG. 5.

The residual vector quantization approach cannot be employed by CGC-VQ because that approach is not designed for constrained VQ problems, and thus cannot in principle maintain the required Cartesian grid constraints.

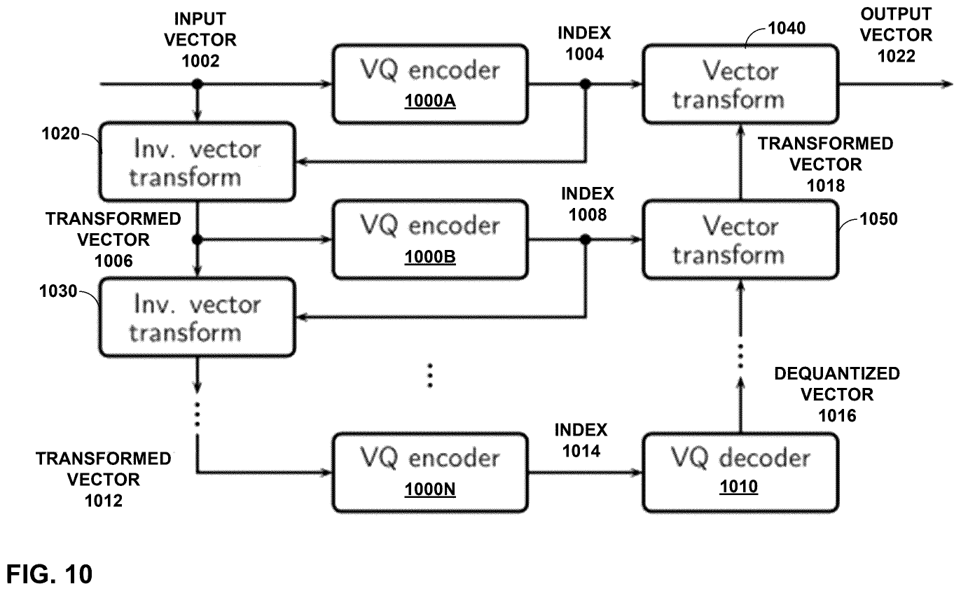

To solve this problem, a new multi-stage scheme incorporates the CGC-VQ constraints, as shown in FIG. 10. FIG. 10 is a block diagram illustrating an example system for implementing procedural multi-stage CGC-VQ, with exponential reduction of codebook memory requirements according to one or more aspects of this disclosure.

This may be achieved by replacing the residual computations with vector transformations that preserve the Cartesian grids. This replacement enables having a VQ coding system where the amount of memory is the sum of memory for each stage, but the total number of VQ code vector is the product of vectors in all the stages.

This scheme can reduce complexity using data transformations that exploit symmetries in distribution of neural network weights and preserve the Cartesian grid.

The example of FIG. 10 may include a plurality of VQ encoders 1000A-1000N operating in parallel. An input vector 1002 (which may represent a neural network weight) may be encoded by VQ encoder 1000A to generate an index 1004. Index 1004 may be input to vector transformer 1040. Index 1004 and input vector 1002 may also be input to inverse vector transformer 1020. A transformed vector 1006, output by inverse vector transformer 1020, may be input to VQ encoder 1000B. VQ encoder 1000B may output an index 1008 that is input to vector transformer 1050. Index 1008 and transformed vector 1006 output by inverse vector transformer 1020 may be input to inverse vector transformer 1030 which may output another transformed vector 1012. This process may repeat for any number of stages N. VQ encoder 1000N (which may be a last VQ encoder) may accept as an input the last transformed vector (e.g., transformed vector 1012) and output an index 1014. Index 1014 may be input to VQ decoder 1010 which may output a dequantized vector 1016. This dequantized vector may be input to the next vector transformer, such as vector transformer 1050. Based on the input dequantized vector 1016 and index 1008 input to vector transformer 1050, vector transformer 1050 may output a transformed vector 1018 to vector transformer 1040. Vector transformer 1040 may, based on the input transformed vector 1018 and the input index 1004, output an output vector 1022.

For example, computing device 402 may execute a first vector quantization encoder to generate a first index based on an input vector, the input vector representing a first respective neural network weight. Computing device 402 may execute a first inverse vector transformer to generate a first transformed vector based on the first index and the input vector. Computing device 402 may execute a last vector quantization encoder to generate a last index based on a previous transformed vector of a previous inverse vector transformer. Computing device 402 may execute a vector quantization decoder to generate a dequantized vector based on the last index. Computing device 402 may execute a first vector transformer to generate an output vector based on a) the first index and b) a transformed vector from a previous vector transformer or the dequantized vector, wherein the output vector represents a first respective compressed neural network weight. In some examples, the first inverse vector transformer is configured to at least one of rotate, flip, or mirror the input vector into a different region of space. In some examples, the first index includes an index of a quadrant in space where the input vector is located. In some examples, the first inverse vector transformer is configured to rotate the input vector to a first quadrant. In some examples, the last index includes an index to a location of the first transformed vector within the first quadrant. In some examples, the first index and the last index represent a first respective compressed neural network weight.

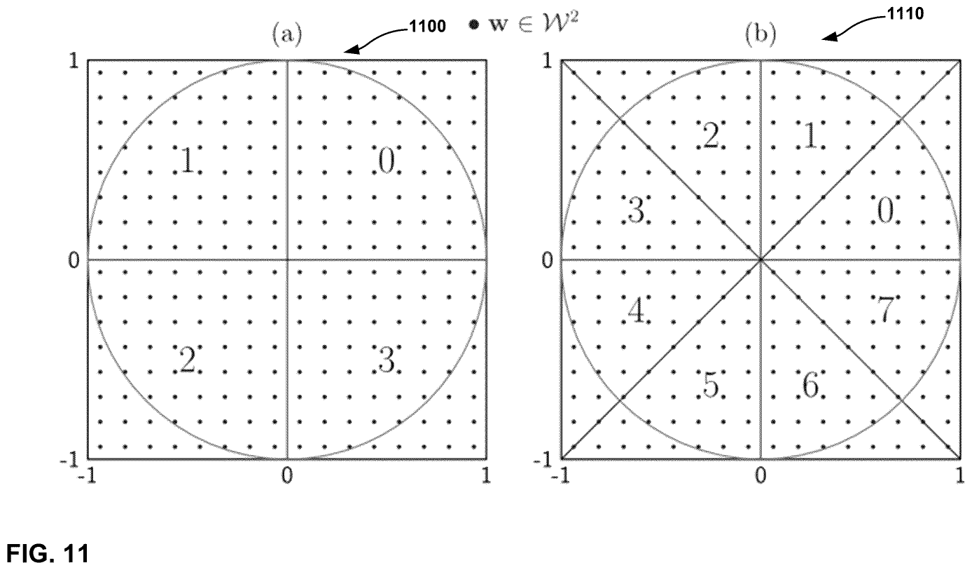

FIG. 11 is a graphical diagram illustrating example of how symmetry in probability distribution may be exploited for two-dimensional CGC-VQ stages, with the index of the vector's region being coded in a first stage, followed by the index of the vector within the region in a second stage. For example, neural network weights commonly have independent values with probability distributions that are approximately Gaussian, and thus the multidimensional vector distribution has approximately a spherical distribution. FIG. 11 shows how in two dimensions one can exploit the circular symmetry from lines crossing the center.

Space [symbol] ² 1100 is divided into four quadrants (0-3), which have probability distributions which correspond the distribution of first quadrant, but rotated by multiples of 90°. In this case, the procedural multi-stage CGC-VQ encoder of computing device 402 can be implemented, with reference to FIG. 10, as follows: 1) VQ encoder 1000A: determine the index q of the quadrant where the input vector is located; 2) Inverse vector transformation 1020: rotate the vector to the first quadrant; 3) VQ encoder 1000B: determine the index s of the code vector within the first quadrant; and encode indexes (q, s).

Space [symbol] ² 1110 shows that the same scheme can applied to other types of divisions of the space [symbol] ², with the caveat that in this example it is necessary to consider that some grid vector can belong to more than one region. For example, space [symbol] ² 1110 is divided into 8 triangular regions (0-7).

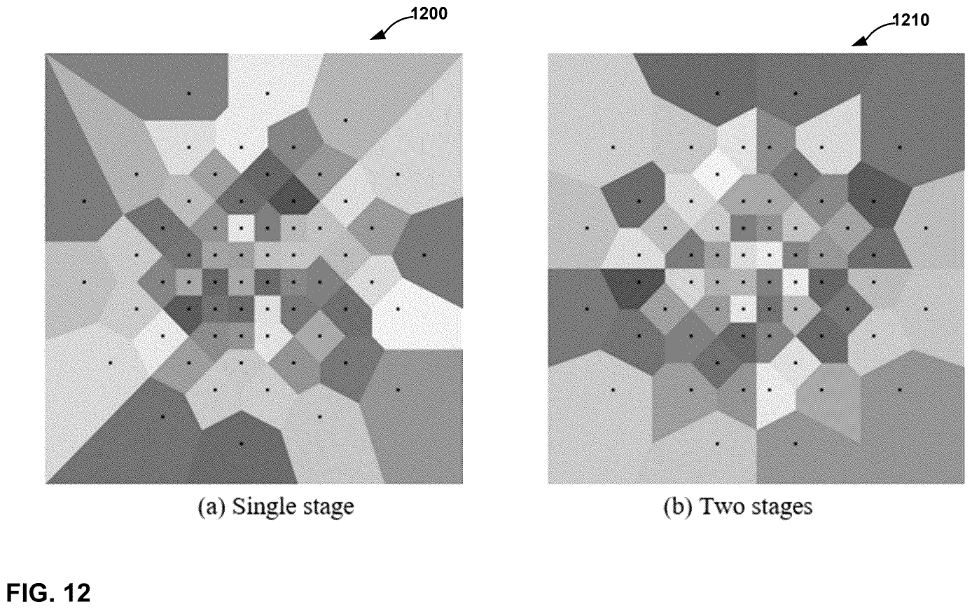

FIG. 12 is a conceptual diagram illustrating single stage and two stage two-dimensional CGC-VQ optimized for squared-error distortion. FIG. 12 depicts two examples how the set of code vectors are changed by the multi-stage implementation. In the example of FIG. 12, the dots represent codebook vectors (|W|=16, M=256, N=64), and the different shaded regions represent vector assignment regions. Space 1200 shows 64 code vectors optimized for a single VQ coding stage. Space 1210 shows 4×16 code vectors optimized for a two-stage procedural VQ (e.g., as shown in FIG. 10), using quadrant regions as in Space [symbol] ² 1100 of FIG. 11. Space 1200 depicts a general solution for the CGC-VQ problem, where patterns related to the symmetry of the distribution can be observed. Space 1210 is optimized for the multiple stage implementation using quadrant symmetry as shown in Space [symbol] ² 1100 of FIG. 11.

Considering the transformations in proposed multi-stage scheme (e.g., of FIG. 10), one can observe in the examples of FIG. 11 that the transformations correspond to “flipping” or “mirroring” operations, and that the transformations preserve the Cartesian grid. Those can be generalized to multiple dimensions using orthogonal transformations, as explained next.

Axis-aligned orthogonal transforms are now discussed. The class of orthogonal transforms can be defined with D-dimensional matrices R such that R^{t}=R⁻¹. Those transformations correspond to multi-dimensional rotations and “flipping,” and in general do not preserve the Cartesian grid.

However, within this class there are many useful special cases, like combinations of reflections and permutations, that can preserve the Cartesian grid, and can be efficiently computed. Those transformations preserve the Cartesian grid by maintaining axis alignments and can be obtained by adding the following constraints to the transformation matrix.

$${R}_{i , j} ∈ \{ - 1 , 0 , 1 \} , {\sum }_{j = 1}^{D} {R}_{i , j} ∈ \{ - 1 , 1 \} , {R}^{t} = {R}^{- 1} . \qquad ( 33 )$$

Those invertible matrices can be directly used as the vector transformations, and respective inverse transformations, in the multiple-stage CGC-VQ system of FIG. 10.

Experimental validation is now discussed. The techniques of this disclosure were tested on neural network weights from a large language model (a modified version of Llama 2), mostly for the case of 4-bit arithmetic.

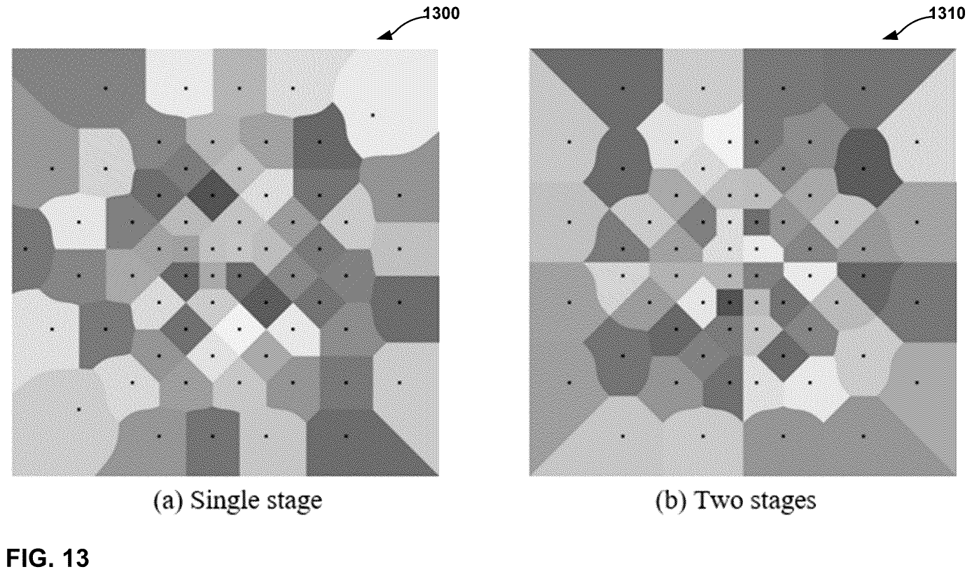

FIG. 13 is a conceptual diagram illustrating single stage and two stage two-dimensional CGC-VQ with the data of FIG. 12, but optimized using the L₄ distortion measure. FIG. 13 shows the results of the CGC-VQ optimization for the conditions of the example of FIG. 12, with parameters | [symbol] |=16, M=256, N=64, but using the L₄ distortion measure instead of L₂ (Euclidean distance). Space 1300 shows a CGC-VQ with single VQ stage. Space 1310 shows a CGC-VQ with two procedural VQ stages exploiting quadrant symmetry.

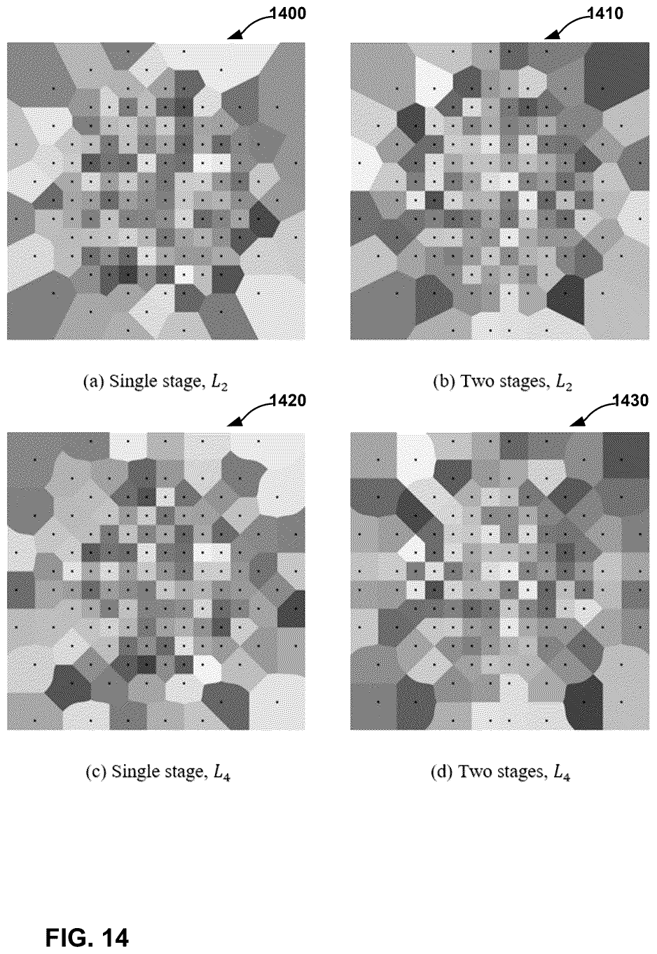

FIG. 14 is a conceptual diagram illustrating example single stage and two stage two-dimensional CGC-VQ with different distortion measures. The examples of FIG. 14 use the parameter N=128 with design parameters |W|=16,M=256,N=128. Space 1400 uses a single stage with the L₂ distortion measure. Space 1410 uses two stages with the L₂ distortion measure. Space 1420 uses a single stage with the L₄ distortion measure. Space 1430 uses two stages with the L₄ distortion measure. These examples demonstrate visually that the techniques of this disclosure maintain the Cartesian grid and find sets of code vectors distributed in a way that matches the NN weight distribution.

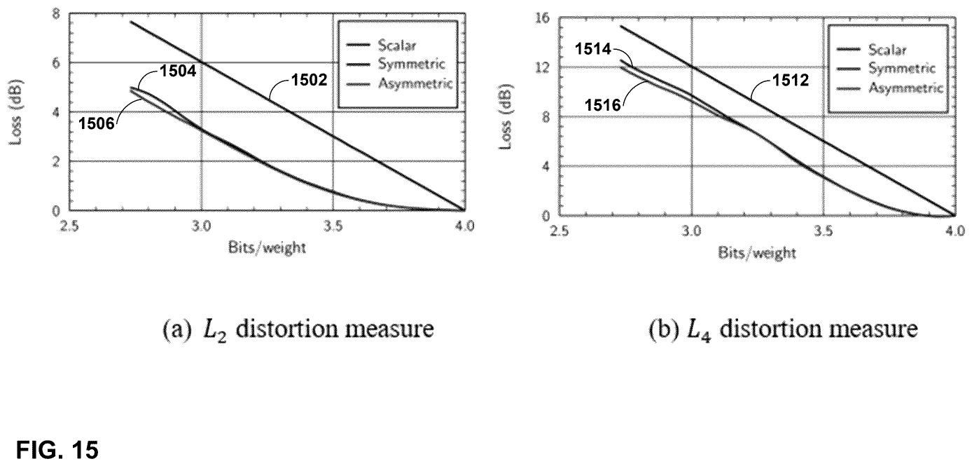

A more precise measure of the CGC-VQ performance may be obtained by analyzing how the quantization error increases with reductions in the number of code vectors. FIG. 15 is a graphical diagram illustrating a comparison of two-dimensional VQ performance with scalar quantization using 4 bits/weight as reference, and between single stage (asymmetric) and two stages (symmetric). For example, for the L₂ distortion measure, line 1502 shows the scalar results, line 1504 shows the symmetric results, and line 1506 shows the asymmetric results. For example, for the L₄ distortion measure, line 1512 shows the scalar results, line 1514 shows the symmetric results, and line 1516 shows the asymmetric results. Each of the graphs of FIG. 15 compare distortion increase in dB compared to 4-bit scalar quantization.

It can be observed that the performance of the multi-stage implementation (labeled “Symmetric” lines 1504 and 1514) is very near that of the single-stage (labeled “Asymmetric” lines 1506 and 1516), demonstrating that the disclosed techniques exploit the properties of the distribution to significantly reduce memory requirements.

The techniques of this disclosure were also tested with 4-dimensional VQ. While such results are not easily visualized, measurements show the effectiveness of these techniques. Such measurements are recorded below in Table I.

TABLE I
Distribution of 4-bit weight coefficient
errors with 4-dimensional CGC-VQ.

| Codebook | | | | | |
|---|---|---|---|---|---|
| size | Bits/weight | \|e\| = 0 | \|e\| = 1 | \|e\| = 2 | \|e\| = 3 |
| 128 × 16 | 2.75 | 79.35% | 20.60% | 0.045% | 0.002% |
| 180 × 16 | 2.87 | 84.02% | 15.95% | 0.023% | 0.001% |
| 256 × 16 | 3.00 | 88.50% | 11.48% | 0.017% | 0.001% |
| 360 × 16 | 3.13 | 91.84% | 8.15% | 0.008% | 0.0002% |
| 512 × 16 | 3.25 | 94.71% | 5.29% | 0.002% | 0 |
| 720 × 16 | 3.38 | 96.81% | 3.19% | 0.001% | 0 |
| 1024 × 16 | 3.50 | 98.29% | 1.71% | 0.0004% | 0 |

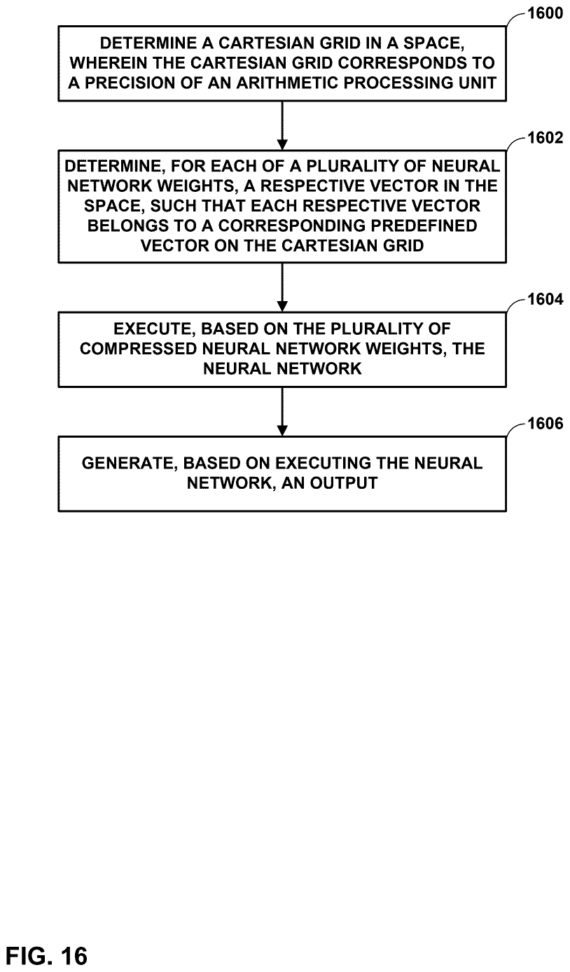

FIG. 16 is a flow diagram illustrating example vector quantization techniques according to one or more aspects of this disclosure. The techniques of FIG. 16 are discussed with respect to computing device 402 but may be practiced by any one or more computing devices capable of performing such techniques.

Computing device 402 may determine a Cartesian grid in a space, wherein the Cartesian grid corresponds to a precision of an arithmetic processing unit (1600). For example, computing device 402 may determine the Cartesian grid using eq. 12 above. The Cartesian grid may correspond to a precision of an arithmetic processing unit, such as an integer precision including 4 bits.

Computing device 402 may determine, for each of a plurality of neural network weights, a respective vector in the space, such that each respective vector belongs to a corresponding predefined vector on the Cartesian grid (1602). Each respective vector may represent a respective compressed neural network weight of a plurality of compressed neural network weights. For example, computing device 402 may align vectors indicative of the plurality of network weights with predefined vectors on the Cartesian grid.

Computing device 402 may execute, based on the plurality of compressed neural network weights, the neural network (1604). For example, computing device 402 may execute neural network model 422 using the compressed neural network weights or decompressed versions of the compressed neural network weights.

Computing device 402 may generate, based on executing the neural network, an output (1606). For example, computing device 402 may generate a prediction, an inference, a classification, and/or the like as an output of neural network model 422.

In some examples, computing device 402 may determine an expected distortion measure. In some examples, computing device 402 may calculate a p-median to optimize a codebook associated with the plurality of compressed neural network weights by minimizing the expected distortion measure. In some examples, as part of calculating the p-median, computing device 402 may not store the expected distortion measure in the one or more memories and not store two-dimensional array values in the one or more memories. In some examples, as part of calculating the p-median, computing device 402 may sort an index according to a distortion measure a single time.

In some examples, computing device 402 may iteratively scan for a plurality of median candidates based on groups of training set vector coordinates with increasing lower bounds on the expected distortion measure and exclude a median candidate of the plurality of median candidates from consideration based on a distortion measure of the median candidate being greater than a predetermined distortion measure. In some examples, computing device 402 may process a quasi-random training data set. In some examples, the quasi-random training data set is based on at least one Sobol sequence.

In some examples, computing device 402 may apply separable non-uniform scalar quantization to input data to determine a plurality of centroids, wherein non-uniform scalar quantization is based on a probability measure; and use the plurality of centroids as training data.

In some examples, computing device 402 may execute a first vector quantization encoder to generate a first index based on an input vector, the input vector representing a first respective neural network weight. Computing device 402 may execute a first inverse vector transformer to generate a first transformed vector based on the first index and the input vector. Computing device 402 may execute a last vector quantization encoder to generate a last index based on a previous transformed vector of a previous inverse vector transformer; execute a vector quantization decoder to generate a dequantized vector based on the last index. Computing device 402 may execute a first vector transformer to generate an output vector based on a) the first index and b) a transformed vector from a previous vector transformer or the dequantized vector, wherein the output vector represents a first respective compressed neural network weight.

In some examples, the first inverse vector transformer is configured to at least one of rotate, flip, or mirror the input vector into a different region of space. In some examples, the first index comprises an index of a quadrant in space where the input vector is located. In some examples, the first inverse vector transformer is configured to rotate the input vector to a first quadrant. In some examples, the last index comprises an index to a location of the first transformed vector within the first quadrant. In some examples, the first index and the last index represent a first respective compressed neural network weight.

Aspects of the techniques of this disclosure include the following clauses.

Clause 1. A device for executing a neural network, the device comprising: one or more memories for storing parameters of the neural network; and one or more processors configured to: determine a Cartesian grid in a space, wherein the Cartesian grid corresponds to a precision of an arithmetic processing unit; determine, for each of a plurality of neural network weights, a respective vector in the space, such that each respective vector belongs to a corresponding predefined vector on the Cartesian grid and represents a respective compressed neural network weight of a plurality of compressed neural network weights; execute, based on the plurality of compressed network weights, the neural network; and generate, based on executing the neural network, an output.

Clause 2. The device of clause 1, wherein the one or more processors are further configured to determine an expected distortion measure.

Clause 3. The device of clause 2, wherein the one or more processors are further configured to calculate a p-median to optimize a codebook associated with the plurality of compressed neural network weights by minimizing the expected distortion measure.

Clause 4. The device of clause 3, wherein as part of calculating the p-median, the one or more processors are configured to not store the expected distortion measure in the one or more memories and not store two-dimensional array values in the one or more memories.

Clause 5. The device of clause 3 or clause 4, wherein as part of calculating the p-median, the one or more processors are configured to sort an index according to a distortion measure a single time.

Clause 6. The device of any of clauses 2-5, wherein the one or more processors are configured to: iteratively scan for a plurality of median candidates based on groups of training set vector coordinates with increasing lower bounds on the expected distortion measure; and exclude a median candidate of the plurality of median candidates from consideration based on a distortion measure of the median candidate being greater than a predetermined distortion measure.

Clause 7. The device of any of clauses 1-6, wherein the one or more processors are further configured to process a quasi-random training data set.

Clause 8. The device of clause 7, wherein the quasi-random training data set is based on at least one Sobol sequence.

Clause 9. The device of clause 1, wherein the one or more processors are further configured to: apply separable non-uniform scalar quantization to input data to determine a plurality of centroids, wherein non-uniform scalar quantization is based on a probability measure; and use the plurality of centroids as training data.

Clause 10. The device of any of clauses 1-9, wherein the one or more processors are configured to: execute a first vector quantization encoder to generate a first index based on an input vector, the input vector representing a first respective neural network weight; execute a first inverse vector transformer to generate a first transformed vector based on the first index and the input vector; execute a last vector quantization encoder to generate a last index based on a previous transformed vector of a previous inverse vector transformer; execute a vector quantization decoder to generate a dequantized vector based on the last index; and execute a first vector transformer to generate an output vector based on a) the first index and b) a transformed vector from a previous vector transformer or the dequantized vector, wherein the output vector represents a first respective compressed neural network weight.

Clause 11. The device of clause 10, wherein the first inverse vector transformer is configured to at least one of rotate, flip, or mirror the input vector into a different region of space.

Clause 12. The device of clause 10 or clause 11, wherein the first index comprises an index of a quadrant in space where the input vector is located, wherein the first inverse vector transformer is configured to rotate the input vector to a first quadrant, wherein the last index comprises an index to a location of the first transformed vector within the first quadrant, and wherein the first index and the last index represent a first respective compressed neural network weight.

Clause 13. A method for executing a neural network, the method comprising: determining a Cartesian grid in a space, wherein the Cartesian grid corresponds to a precision of an arithmetic processing unit; determining, for each of a plurality of neural network weights, a respective vector in the space, such that each respective vector belongs to a corresponding predefined vector on the Cartesian grid and represents a respective compressed neural network weight of a plurality of compressed neural network weights; executing, based on the plurality of compressed network weights, the neural network; and generating, based on executing the neural network, an output.

Clause 14. The method of clause 13, further comprising determining an expected distortion measure.

Clause 15. The method of clause 14, further comprising calculating a p-median to optimize a codebook associated with the plurality of compressed neural network weights by minimizing the expected distortion measure.

Clause 16. The method of clause 14 or clause 15, further comprising: iteratively scanning for a plurality of median candidates based on groups of training set vector coordinates with increasing lower bounds on the expected distortion measure; and excluding a median candidate of the plurality of median candidates from consideration based on a distortion measure of the median candidate being greater than a predetermined distortion measure.

Clause 17. The method of any of clauses 13-16, further comprising: executing a first vector quantization encoder to generate a first index based on an input vector, the input vector representing a first respective neural network weight; executing a first inverse vector transformer to generate a first transformed vector based on the first index and the input vector; executing a last vector quantization encoder to generate a last index based on a previous transformed vector of a previous inverse vector transformer; executing a vector quantization decoder to generate a dequantized vector based on the last index; and executing a first vector transformer to generate an output vector based on a) the first index and b) a transformed vector from a previous vector transformer or the dequantized vector, wherein the output vector represents a first respective compressed neural network weight.

Clause 18. The method of clause 17, wherein the first inverse vector transformer is configured to at least one of rotate, flip, or mirror the input vector into a different region of space.

Clause 19. The method of clause 17 or clause 18, wherein the first index comprises an index of a quadrant in space where the input vector is located, wherein the first inverse vector transformer is configured to rotate the input vector to a first quadrant, wherein the last index comprises an index to a location of the first transformed vector within the first quadrant, and wherein the first index and the last index represent a first respective compressed neural network weight.

Clause 20. A device for coding video data, the device comprising: means for determining a Cartesian grid in a space, wherein the Cartesian grid corresponds to a precision of an arithmetic processing unit; means for determining, for each of a plurality of neural network weights, a respective vector in the space, such that each respective vector belongs to a corresponding predefined vector on the Cartesian grid and represents a respective compressed neural network weight of a plurality of compressed neural network weights; means for executing, based on the plurality of compressed network weights, the neural network; and means for generating, based on executing the neural network, an output.

In one or more examples, the functions described may be implemented in hardware, software, firmware, or any combination thereof. If implemented in software, the functions may be stored on, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined coder. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a coder hardware unit or provided by a collection of interoperative hardware units, including one or more processors as described above, in conjunction with suitable software and/or firmware.

This disclosure also includes attached appendices, which forms part of this disclosure and is expressly incorporated herein. The techniques disclosed in the appendices may be performed in combination with or separately from the techniques disclosed herein.

Various examples have been described. These and other examples are within the scope of the following claims.

What is claimed is:

1. A device for executing a neural network, the device comprising:
one or more memories for storing parameters of the neural network; and
one or more processors configured to:
determine a Cartesian grid in a space, wherein the Cartesian grid corresponds to a precision of an arithmetic processing unit;
determine, for each of a plurality of neural network weights, a respective vector in the space, such that each respective vector belongs to a corresponding predefined vector on the Cartesian grid and represents a respective compressed neural network weight of a plurality of compressed neural network weights;
execute, based on the plurality of compressed network weights, the neural network; and
generate, based on executing the neural network, an output.

2. The device of claim 1, wherein the one or more processors are further configured to determine an expected distortion measure.

3. The device of claim 2, wherein the one or more processors are further configured to calculate a p-median to optimize a codebook associated with the plurality of compressed neural network weights by minimizing the expected distortion measure.

4. The device of claim 3, wherein as part of calculating the p-median, the one or more processors are configured to not store the expected distortion measure in the one or more memories and not store two-dimensional array values in the one or more memories.

5. The device of claim 3, wherein as part of calculating the p-median, the one or more processors are configured to sort an index according to a distortion measure a single time.

6. The device of claim 2, wherein the one or more processors are configured to:
iteratively scanning for a plurality of median candidates based on groups of training set vector coordinates with increasing lower bounds on the expected distortion measure; and
excluding a median candidate of the plurality of median candidates from consideration based on a distortion measure of the median candidate being greater than a predetermined distortion measure.

7. The device of claim 1, wherein the one or more processors are further configured to process a quasi-random training data set.

8. The device of claim 7, wherein the quasi-random training data set is based on at least one Sobol sequence.

9. The device of claim 1, wherein the one or more processors are further configured to:
apply separable non-uniform scalar quantization to input data to determine a plurality of centroids, wherein non-uniform scalar quantization is based on a probability measure; and
use the plurality of centroids as training data.

10. The device of claim 1, wherein the one or more processors are configured to:
execute a first vector quantization encoder to generate a first index based on an input vector, the input vector representing a first respective neural network weight;
execute a first inverse vector transformer to generate a first transformed vector based on the first index and the input vector;
execute a last vector quantization encoder to generate a last index based on a previous transformed vector of a previous inverse vector transformer;
execute a vector quantization decoder to generate a dequantized vector based on the last index; and
execute a first vector transformer to generate an output vector based on a) the first index and b) a transformed vector from a previous vector transformer or the dequantized vector, wherein the output vector represents a first respective compressed neural network weight.

11. The device of claim 10, wherein the first inverse vector transformer is configured to at least one of rotate, flip, or mirror the input vector into a different region of space.

12. The device of claim 10, wherein the first index comprises an index of a quadrant in space where the input vector is located, wherein the first inverse vector transformer is configured to rotate the input vector to a first quadrant, wherein the last index comprises an index to a location of the first transformed vector within the first quadrant, and wherein the first index and the last index represent a first respective compressed neural network weight.

13. A method for executing a neural network, the method comprising:
determining a Cartesian grid in a space, wherein the Cartesian grid corresponds to a precision of an arithmetic processing unit;
determining, for each of a plurality of neural network weights, a respective vector in the space, such that each respective vector belongs to a corresponding predefined vector on the Cartesian grid and represents a respective compressed neural network weight of a plurality of compressed neural network weights;
executing, based on the plurality of compressed network weights, the neural network; and
generating, based on executing the neural network, an output.

14. The method of claim 13, further comprising determining an expected distortion measure.

15. The method of claim 14, further comprising calculating a p-median to optimize a codebook associated with the plurality of compressed neural network weights by minimizing the expected distortion measure.

16. The method of claim 14, further comprising:
iteratively scanning for a plurality of median candidates based on groups of training set vector coordinates with increasing lower bounds on the expected distortion measure; and
excluding a median candidate of the plurality of median candidates from consideration based on a distortion measure of the median candidate being greater than a predetermined distortion measure.

17. The method of claim 13, further comprising:
executing a first vector quantization encoder to generate a first index based on an input vector, the input vector representing a first respective neural network weight;
executing a first inverse vector transformer to generate a first transformed vector based on the first index and the input vector;
executing a last vector quantization encoder to generate a last index based on a previous transformed vector of a previous inverse vector transformer;
executing a vector quantization decoder to generate a dequantized vector based on the last index; and
executing a first vector transformer to generate an output vector based on a) the first index and b) a transformed vector from a previous vector transformer or the dequantized vector, wherein the output vector represents a first respective compressed neural network weight.

18. The method of claim 17, wherein the first inverse vector transformer is configured to at least one of rotate, flip, or mirror the input vector into a different region of space.

19. The method of claim 17, wherein the first index comprises an index of a quadrant in space where the input vector is located, wherein the first inverse vector transformer is configured to rotate the input vector to a first quadrant, wherein the last index comprises an index to a location of the first transformed vector within the first quadrant, and wherein the first index and the last index represent a first respective compressed neural network weight.

20. A device for executing a neural network, the device comprising:
means for determining a Cartesian grid in a space, wherein the Cartesian grid corresponds to a precision of an arithmetic processing unit;
means for determining, for each of a plurality of neural network weights, a respective vector in the space, such that each respective vector belongs to a corresponding predefined vector on the Cartesian grid and represents a respective compressed neural network weight of a plurality of compressed neural network weights;
means for executing, based on the plurality of compressed network weights, the neural network; and
means for generating, based on executing the neural network, an output.
